(19) United States
(12) Patent Application Publication
(10) Pub. No.: US 2026/0239281 A1
(43) Pub. Date: Aug. 13, 2026

(54) MEASUREMENT AND FEEDBACK FOR CARRIER PHASE POSITIONING

(71) Applicant: Apple Inc., Cupertino, CA (US)

(72) Inventors: Oghenekome Oteri, San Diego, CA (US); Dawei Zhang, Saratoga, CA (US); Haitong Sun, Saratoga, CA (US); Seyed Ali Akbar Fakoorian, San Diego, CA (US); Wei Zeng, Saratoga, CA (US); Weidong Yang, San Diego, CA (US)

(21) Appl. No.: 19/156,627

(22) PCT Filed: Feb. 16, 2024
(86) PCT No.: PCT/US2024/016175

§ 371 Date: Aug. 14, 2025

Related U.S. Application Data
(60) Provisional application No. 63/446,618, filed on Feb. 17, 2023.

(51) Int. Cl. H04W 64/00

(52) U.S. Cl. CPC H04W 64/00

(57) ABSTRACT

Methods and systems include receiving, at network entity, capability data describing carrier phase (CP) measurement parameters for a target user equipment (UE); receiving, at the network entity, position reference unit (PRU) capability data; sending, to the target UE, first configuration data specifying a first timing for performing position measurements; sending, to a PRU UE, second configuration data specifying a second timing for performing the position measurements; receiving, from the target UE, first feedback data specifying a first position measurement including carrier phase data; receiving, from the PRU UE, second feedback data specifying a second position measurement including carrier phase data; and determining, based on the first feedback data and the second feedback data, a position estimate for the target UE.

### CLAIM OF PRIORITY

This application claims priority to U.S. Patent Application Ser. No. 63/446,618, filed on Feb. 17, 2023, the entire contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

This document specifies physical layer measurements and signaling to support NR DL and UL carrier phase positioning for UE-based, UE-assisted, and NG-RAN node assisted positioning. A UE is configured to use existing DL PRS and UL SRS for positioning for NR carrier phase measurements. The UE then uses additional measurements, previously identified (e.g., UL SRS, DL PRS, etc.), that are limited to a single carrier or position frequency layer (PFL). This document specifies how these measurements are performed (e.g., by a UE or TRP), how to signal to a device to perform these measurements, how these measurements are reported or fed back to the network, and how these measurements are used in the network for CPP. Specifically, this document describes how to indicate the capabilities of the UE/TRP/LMF for CPP. This document describes both how these devices indicate general capabilities and indicate processing capabilities. This document describes how the UE is configured for measurements and feedback needed for the integer ambiguity estimation. For example, the UE is configured for integer ambiguity estimation with single or multiple carrier phase (CP) measurements. This document describes the UE/TRP procedure for standalone and joint CPP. For example, a first solution includes location management function (LMF)-based DL NR carrier phase positioning. A second solution includes UE-based DL NR carrier phase positioning. A third solution includes LMF-based UL NR carrier phase positioning.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates a flow diagram for an example process.

FIG. 3 shows a signal flow diagram including a process for LMF-based DL NR carrier phase positioning.

FIG. 4 shows a signal flow diagram including a process for UE-based DL NR carrier phase positioning.

FIG. 5 shows a signal flow diagram including a process for LMF-based UL NR carrier phase positioning.

FIGS. 6A-6C each illustrate a flow diagram for an example process.

FIG. 7 illustrates an example user equipment (HE), according to some implementations.

FIG. 8 illustrates an example access node, according to some implementations.

### DETAILED DESCRIPTION

This document describes systems and processes for determining a distance between a transmitter and receiver using carrier phase positioning (CPP) measurements for new radio (NR) networks. In legacy telecommunications networks, Radio Access Technology (RAT)-based positioning methods are used for location based services (LBS). The accuracy of RAT-based positioning can be relatively low (e.g., several meters, 1-3 meters, or more). This document describes methods and systems to improve the accuracy of position determination for devices in the wireless network based on CPP measurements to attain centimeter level accuracy. These measurements are configured to be used in Fifth Generation (5G) networks, Sixth Generation networks (6G), etc.

To estimate the distance (d) between the transmitter and receiver, a system, as a user equipment (UE), can calculate Equation (1):

$$d = ( ϕ + N + {ϕ}_{tx} + {ϕ}_{rx} ) λ \qquad ( 1 )$$

where d is the distance between the transmitter and receiver, (P is the normalized fractional carrier phase measurement (normalized by 2π) between the transfer reference point (TRP) and the user equipment, N is the unknown integer ambiguity (e.g., total phase cycles) in the carrier phase measurement (in cycles), k is a carrier wavelength, and \hat{φ}ₜₓ, \hat{φ}ᵣₓ are phase offsets due to imperfect synchronization (such as clock offsets).

The UE performs a CPP process to determine the distance d by estimating an integer ambiguity and by eliminating clock offsets. For the purposes of discussion, for NR downlink and/or uplink carrier phase positioning, the carrier phase (CP) at a radio frequency (RF) at a receiver is a phase that is a function of the signal propagation time from an Tx antenna reference point of a transmitter (e.g., a TRP or a UE) to a Rx antenna reference point of the receiver (e.g., a UE or a TRP). The propagation time can be expressed in a fractional part of a cycle of the RF frequency and a number of integer cycles, but the CP is independent of the number of integer cycles. The range between a transmitter and a receiver is measured in complete wavelengths (an integer) and a fraction of a wavelength. The carrier phase measures the final fraction of a wavelength, but the measurement is subject to different error sources. The carrier phase measurement is obtained from the complex angle of the estimated channel impulse response at the delay of the line of sight (LOS) peak.

The UE is configured to use existing downlink (DL) positioning reference signal (PRS) and sounding reference signal (SRS) signals to obtain the carrier phase measurements for achieving a horizontal accuracy of up to a few centimeters at least at 50% under certain conditions. These conditions include scenarios in which positioning reference unit(s) (PRU(s)) are located in a LOS with the TRP(s), and the locations of the PRU(s) and TRPs are known with centimeter-level accuracy.

Regarding the reference signals for NR carrier phase positioning, a UE uses existing DL PRS and uplink (UL) SRS signals as reference signals to enable positioning based on NR carrier phase measurements. The DL PRS and UL SRS signals are used for both UE-based and UE-assisted positioning for NR CPP. Regarding physical layer measurements for NR carrier phase positioning, new measurements are introduced for supporting UE-based and UE-assisted NR carrier phase positioning. The non-legacy measurements include, at least, the following. For DL carrier phase positioning, the non-legacy measurements include a measurement of at least a difference between a carrier phase measured from the DL PRS signal(s) of the target TRP and a carrier phase measured from the DL PRS signal(s) of the reference TRP. For DL carrier phase positioning, the non-legacy measurements include a measurement of at least the carrier phase measured from the DL PRS signal(s) of a TRP. For UL carrier phase positioning, the non-legacy measurements include at least carrier phases measured from the UL SRS for a positioning purpose. The carrier phase measurements described herein are not mapped to a specific positioning technique.

Multipath mitigation methods for the carrier phase positioning are described herein. The mitigation methods include may include, but are not limited to, the following examples. A first example includes reporting, by the UE, the carrier phase of a first path in the multipath scenario. This solution includes reporting, by the UE, the carrier phase of the first path, and optionally, the additional paths. This includes can include using, by the UE, LOS or non-line of sight (NLOS) indication for carrier phase measurements. A second example includes reporting of channel information together with carrier phase measurements, such as existing reference signal received power or reference signal received path power (RSRP/RSRPP), to perform CPP. Double differential technique with PRU is feasible for UE-based and network-based NR carrier phase positioning. This can eliminate error from initial phases of the transmitter and the receiver. Other methods for eliminating the impact of the initial phases of the transmitter and the receiver are not precluded

This document specifies physical layer measurements and signaling to support NR DL and UL carrier phase positioning for UE-based, UE-assisted, and NG-RAN node assisted positioning. A ULE is configured to use existing DL PRS and UL SRS for positioning for NR carrier phase measurements. The UE then uses additional measurements, previously identified (e.g., UL SRS, DL PRS, etc.), that are limited to a single carrier or one or more position frequency layers (PFLs). This document specifies how these measurements are performed (e.g., by a UE or TRP), how to signal to a device to perform these measurements, how these measurements are reported or fed back to the network, and how these measurements are used in the network for CPP. Specifically, this document describes how to indicate the capabilities of the UE/TRP/LMF for CPP. This document describes both how these devices indicate general capabilities and indicate processing capabilities. This document describes how the UE is configured for measurements and feedback needed for the integer ambiguity estimation. For example, the UE is configured for integer ambiguity estimation with single or multiple carrier phase (CP) measurements. This document describes the UE/TRP procedure for standalone and joint CPP. For example, a first solution includes location management function (LMF)-based DL NR carrier phase positioning. A second solution includes UE-based DL NR carrier phase positioning. A third solution includes LMF-based UL NR carrier phase positioning.

This document describes the procedure details for the following scenarios. This document describes signaling for joint and standalone CPP including multi-round trip time (RTT) signaling. This document describes signaling for joint and standalone CPP downlink time difference of arrival (CPP-DL-TDoA) based signaling. This document describes signaling for joint and standalone CPP uplink TDoA (CPP-UL-TDoA).

This document describes how to handle CPP that fails in multipath channels. Devices are configured for CPP indication and feedback for multipath channels. This document also describes carrier phase position reference signal (CP-PRS) design.

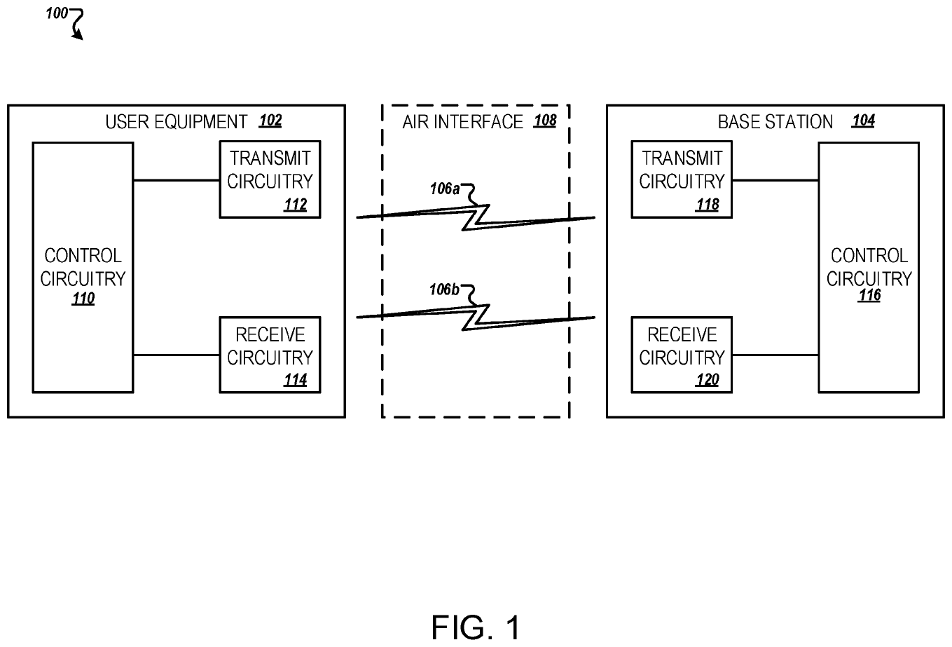

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE. For instance, the control circuitry 110 can cause the UE to perform UL SRS or DL PRS measurements as described herein. The control circuitry can also cause the UE to signal these measurements to other devices in the network as described herein.

The transmit circuitry 112 can perform various operations described in this specification. For example, the transmit circuitry 112 can signal the UL SRS or DL PRS measurements in accordance with the signaling and feedback procedures described herein. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can receive instructions that configure the UE to perform UL SRS or DL PRS measurements for standalone and joint CPP and for signaling for joint and standalone CPP including multi-round trip time (RTT) signaling. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, an LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

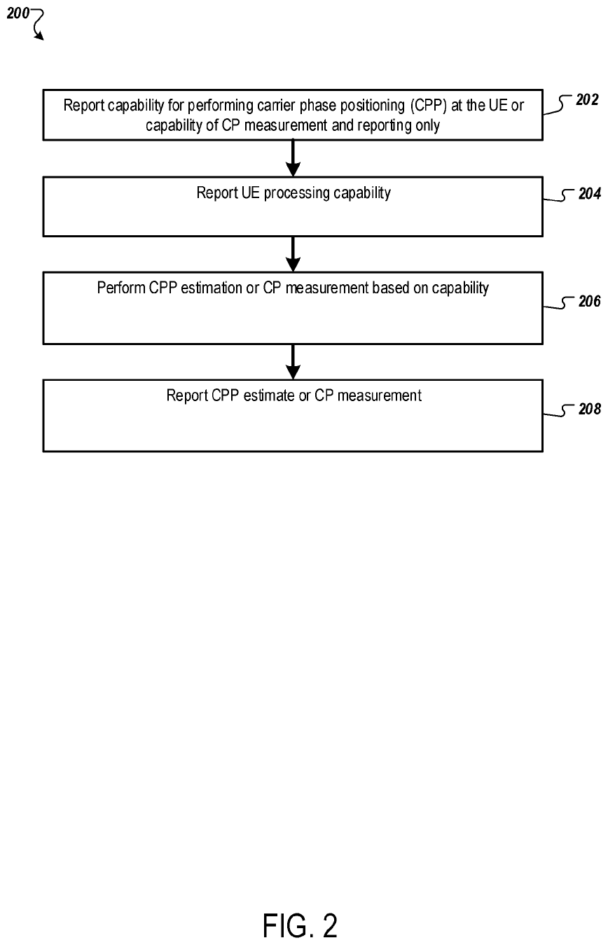

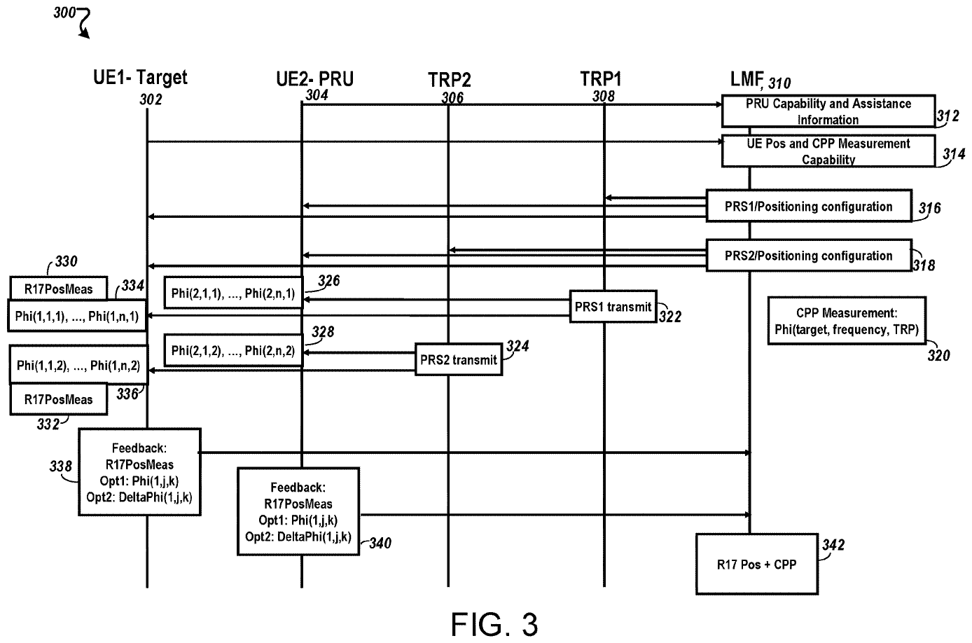

FIG. 2A illustrates a flowchart of an example method 200, according to some implementations. For clarity of presentation, the description that follows generally describes method 200 in the context of the other figures in this description. For example, method 200 can be performed by UE 102 of FIG. 1 (or a TRP or LMF of FIGS. 3-5). It will be understood that method 200 can be performed, for example, by any suitable system, environment, software, hardware, or a combination of systems, environments, software, and hardware, as appropriate. In some implementations, various steps of method 200 can be run in parallel, in combination, in loops, or in any order.

For performing the method 200, a device of a network is configured to indicate (202) its capabilities. The device can include one of a UE/TRP/LMF for CPP. For example, a UE is configured to report whether it is capable of measuring carrier phase for positioning (e.g., performing actual CPP), or calculating a carrier phase estimate to be used for positioning determination. In some implementations, the UE is not capable of calculating a position based on the carrier phase. The UE is configured to signal whether the UE can measure the carrier phase only, and report this measurement to another device (e.g., the LMF) for estimating the ULE position. The UE is configured to report whether it is capable of being a PRU, in which a position of the UE is known. If the UE can be a PRU, the UE can signal whether it is configured for double differential CPP.

In an aspect, the UE indicates a capability to support a combination of NR carrier phase positioning with another standardized Rel. 17 positioning method only. The capability indicates a specific type of method, such as e.g. DL-TDOA, UL-TDOA, Multi-RTT. The UE is configured for simultaneous DL-TDOA/UL-TDOA/Multi-RTT and CPP processing. For NR carrier phase positioning, The UE is configured to enable a UE/TRP to report carrier phase measurements together with the legacy positioning measurements to the LMF. The UE can use legacy positioning measurements among RSTD, RTOA, UE Rx-Tx time difference measurements, and base station Rx-Tx time difference measurements.

In an aspect, an LMF can request a UE, which can be a target UE and a PRU, to perform measurements on indicated DL PRS resource set(s) occurring within an indicated time window. The UE may use the indicated DL PRS resource set(s) occurring outside the indicated time window for legacy measurements in addition to the indicated DL PRS resource set(s) occurring inside the indicated time window.

In an aspect, the UE can perform legacy measurements inside the indicated time window only. The UE can have a configured to enable legacy measurements inside the time window only.

A UE can report (202) that the UE is capable of performing CPP at the UE itself. If the UE is capable of performing CPP, the UE reports further capabilities as to how it can perform CPP. For example, for UE-based CPP, the UE can indicate a capability to support a DL carrier phase positioning (and only a DL CPP) based on carrier measurements. In some implementations, the UE indicates a capability to support a multi-frequency based CPP estimation, such as using a process including a virtual frequency based integer ambiguity estimation (e.g., for estimating the value of N of Equation 1). In some implementations, the UE indicates a capability to support a single frequency-based CPP estimation. For example, the UE can be configured for a multi-hypothesis integer ambiguity estimation. In some implementations, the UE indicates a capability to support a combination of DL CPP in a new radio network and a legacy positioning method. For example, the legacy positioning method can include a specific type of method such as DL-TDOA, UL-TDOA, Multi-RTT, and so forth. In this example, the legacy method may be used to get a rough position estimate that is refined using CPP. In some implementations, the UE can indicate support for simultaneous DL-TDOA/UL-TDOA/Multi-RTT and CPP processing. In some implementations, the UE indicates support for standalone NR CPP only. In another example, the UE indicates support for both standalone new radio CPP described herein and joint legacy/CPP positioning. In another example, the UE indicates capability to support double differential new radio CPP described herein for UE-based positioning.

The UE determines if the UE is capable of CP measurement only or CP measurement and position estimation. Generally, the determination is made in the capability reporting of step 202. If the UE is capable of supporting CPP estimation, the UE reports a level of support for CPP estimation or CP measurement. For example, the UE capabilities for carrier phase measurement and reporting are described below and are generally for both LMF-based CPP estimation and UE-based CPP estimation. In a first example, the UE indicates capability to support a single CP measurement across multiple PFLs or a single PFL simultaneously. In a second example, the UE indicates capability to support a single CP measurement across multiple PFL(s) simultaneously and with a time of arrival (TOA) estimation. In a third example, the UE indicates capability to support up to a given number N of CP measurements across multiple PFL(s), simultaneously. In this example, if multiple PFLs are provided, the UE can estimate the N CPP measurements at the same time. For example, the UE supports associating a single Rx-Tx or RSTD measurement with up to N_sample RSCP/RSCPD measurement. For example, the UE supports associating a single Rx-Tx or RSTD measurement with up to N_sample RSCP/RSCPD measurements. In a fourth example, the UE indicates capability to support up to a given number M of CP measurements across multiple PFLs, sequentially. In this example, if multiple PFLs are provided, the UE can estimate the N CPP measurements one after another. In a fifth example, the UE indicates capability to associate a given number N of legacy position measurement occasions, such as time difference of arrival (TDOA) measurement occasions, downlink angle of departure (DL-AoD) measurement occasions, etc., with a CPP measurement occasion in a report occasion. In this example, there is a single CPP measurement associated with all the legacy position measurements of the group of N measurements. In some implementations, the M number of legacy position measurement occasions and associated CPP measurement occasion can be distributed across different CPP report occasions. In a sixth example, the UE indicates a capability to associate every given number (K) CPP measurement occasions with a legacy measurement occasion, such as TDOA, DL-AoD, etc., within a report occasion. In this example, a single legacy position measurement is associated with each of the K CPP measurement occasions. As previously stated, this association can be useful for position refinement of the UE. In some implementations, the given number K of CPP report occasions and associated legacy measurement occasion can be distributed across different report occasions.

The UE may report that it is configured to be a PRU. The PRU capability and configuration can include the following. The UE indicates a capability to support carrier phase positioning as a PRU, generally. The UE indicates one of the previously described configurations for CPP estimation or CP measurement. The UE indicates its actual position. The actual position that the UE reports can include an error estimate of the position. The error estimate is needed for the double differential estimation. Generally, the error estimate ensures an accuracy with centimeter precision. The UE can indicate an accuracy measure based including a position accuracy, a CPP accuracy, and an RSPP of path for position measurement. This data enables a base station (such as base station 104 of FIG. 1) to designate the UE as a PRU.

The UE indicates (204) a processing capability with CPP, including joint CPP processed with traditional positioning or standalone CPP processing. The UE reports DL PRS processing capability that specifies the UE's processing capabilities including the following. A maximum DL PRS bandwidth is reported (e.g., in megahertz MHz). The bandwidth value that is supported is reported by the UE. The UE reports DL PRS buffering capability as Type 1, which includes sub-slot or symbol level buffering, or Type 2, which includes slot level buffering. The UE reports a duration of DL PRS symbols N in units of milliseconds in which a UE can process every T ms assuming maximum DL PRS bandwidth in MHz, which is supported and reported by UE. In a first example, the UE reports a duration of the DL PRS as follows. For the UE DL PRS processing capability, the UE reports, as supported by the UE, one combination of (N, T) values per band. N is the duration of DL PRS processing systems (in milliseconds) processed every T milliseconds for a given maximum bandwidth (B) in megahertz.

In a first example, the following values for N, T, and B are supported. N can be one of 0.125, 0.25, 0.5, 1, 2, 4, 8, 12, 16, 20, 25, 30, 35, 40, 45, or 50 ms. T can be one of 8, 16, 20, 30, 40, 80, 160, 320, 640, or 1280 milliseconds. The maximum DL PRS bandwidth (in MHz) can be reported for FR1 or FR2. For FR1, the values include 5, 10, 20, 40, 50, 80, or 100 MHz. For FR2, the values include 50, 100, 200, or 400 MHz. The reporting of the (N, T) values for the maximum bandwidth is not dependent on SCS. The UE also reports a number of DL PRS resources that the UE can process in a slot, which is reported per SCS per band. Values reported by the UE for the FR1 bands are selected from 1, 2, 4, [6], 8, 12, 16, [24], 32, [48], or 64 for each SCS (15 kilohertz (kHz), 30 kHz, or 60 kHz). Values reported by the UE for the FR2 bands are selected from 1, 2, 4, [6], 8, 12, 16, [24], 32, [48], or 64 for each SCS (60 kHz, 120 kHz). This includes measurements for TDoA, AoA, etc.

In a second example, a joint combination for CPP and legacy positioning is performed. In this example, the UE reports updated values for T and N are reported by the UE. As previously discussed, N is a duration of DL PRS symbols in ms processed every T ms for a given maximum bandwidth (B) in MHz supported by UE. Specifically, the UE is configured to report a maximum number of DL PRS resources that the UE can process in a slot under it for FR1 and FR2 bands. These include the following values for N={0.125, 0.25, 0.5, 1, 2, 4, 8, 12, 16, 20, 25, 30, 35, 40, 45, 50} ms. These include the following values for T={8, 16, 20, 30, 40, 80, 160, 320, 640, 1280} ms. The values for the maximum DL PRS BW in MHz, reported by the UE, include for FR1: {5, 10, 20, 40, 50, 80, 100 } MHz. The values for the maximum DL PRS BW in MHz, reported by the UE, include for FR2: {50, 100, 200, and 400} MHz. The reporting of (N, T) values for maximum BW in MHz is not dependent on SCS.

In a third example, a joint combination for CPP and legacy positioning is performed. The UE reports a difference between new and legacy values for T and N (ΔT, ΔN) which is added to existing values to accommodate additional carrier phase measurements and/or UE CPP processing. Specifically, ΔN includes an additional processing time for single or joint CPP for the UE. Specifically, ΔT includes the additional processing time for single or joint CPP for the UE.

In some implementations, the UE reports one combination of (N+ΔN, T+ΔT) values per band. In a first example, for N and T being unchanged, the offset values ΔN and ΔT are 0. In a second example, the value of ΔN and ΔT are non-zero and equal. In a third example, the values of ΔN and ΔT are not equal (and either can be zero). Each of these examples can enable the UE to represent processing capability for CPP measurement or estimation and/or reporting.

The UE is configured to estimate (206) the integer ambiguity (N) of Equation (1). Scenarios for a single PFL or carrier are now described. The CPP estimator (e.g., the UE, TRP, LMF, etc.) can perform the following actions. The CPP estimator can estimate N based on a single CP within a carrier/positioning frequency layer. The estimator can use an approach such as using integer least squares. In another example, the CPP estimator can estimate N based on multiple carrier phases within one or more carriers/positioning frequency layers (e.g. using virtual wavelength methods).

The estimator is configured for the measurements and feedback needed for each case as follows. For a single CP within a PFL or carrier, the estimator (e.g., the UE) configures one PFL or carrier for CPP with feedback of a single CP per PFL or carrier. For the single CP, the UE uses feedback of the RSRP or of the RSRP of the first path as the assistance information for position estimation. In some implementations, the UE uses this assistance information of a search range of the integer ambiguity.

The estimator is configured for the measurements and feedback needed for multiple CPs within a PFL or carrier as follows. The estimator (e.g., a UE) configures one PFL or carrier for CPP, with feedback of multiple CPs per PFL or carrier. In some implementations, the UE configures the frequencies at which the carrier phase measurement will be made within the same PFL/carrier. In some implementations, the UE configures the number of carrier phase measurements to be made in a PFL/carrier. The UE estimates frequencies. For example, the UE divides the bandwidth into equal lengths, and a tone is the center of each sub-bandwidth. In some implementations, the UE reports feedback from the TOA and carrier phase measurement in the center of bandwidth. The UE can estimate analytically additional carrier phase values. In some implementations, the UE provides feedback of the RSRP, of the RSRP of the first path, or of the RSPP of the sub-bandwidth as assistance information for position estimation. In some implementations, the UE (or TRP, etc.) autonomously provides feedback including a given number (X) carrier phase measurements per PFL/carrier. The UE can also report the corresponding subcarrier index. In some implementations, the UE provides assistance information on a search range of the integer ambiguity for each possible virtual frequency.

The integer ambiguity estimation for multiple PFLs or/carriers is now described. The system is configured to support a UE/TRP to report the carrier phase measurements of more than one frequency within a PFL/carrier to LMF. The frequency can be the carrier frequency or the frequency of a subcarrier. A type of UE/TRP measurement can be based on carrier phase differentials across multiple subcarriers within a PFL/carrier. Carrier phase differentials across multiple subcarriers within a carrier can be related to time of arrival. The UE can support a UE/TRP to optionally report an estimated integer ambiguity and/or search range of the integer ambiguity to LMF. The UE can support LMF to provide the expected integer ambiguity range at least for UE-based NR CPP in the positioning assistance data.

A simultaneous reception of DL PRS from multiple frequency layers is not supported in legacy systems. Here, multiple PFLs are allowed based on band aggregation. The timing errors of the PFLs may not be the same for PFLs in different bands or frequency ranges. The UE configures separate PFLs for each carrier phase measurement either in a same band or across multiple bands. The PLFs do not have to be contiguous or in the same band. The estimator (e.g., the UE, TRP, etc.) can use double differential CPP to eliminate timing errors and multiple bands to estimate integer ambiguity when multiple PFLs are being used. The estimator (e.g., the UE, TRP, etc.) can use assistance information on the search range of the integer ambiguity.

Generally, the estimating device (e.g., the UE, TRP, etc.) is configured to semi-statically or dynamically set frequency tones, carriers, or PLFs at which measurements are being taken. In some implementations, the PRS and SRS are simultaneously transmitted. In some implementations, the PRS and SRS are sequentially transmitted. In this latter case, the time different between transmissions is configured. For example, the UE configures the time difference explicitly, the time difference is implicitly captured, and/or the UE indicates a maximum time difference that can be tolerated. The UE (or TRP, etc.) reports (208) the CPP estimate to the network. Reporting is subsequently described in relation to FIGS. 3, 4, and 5.

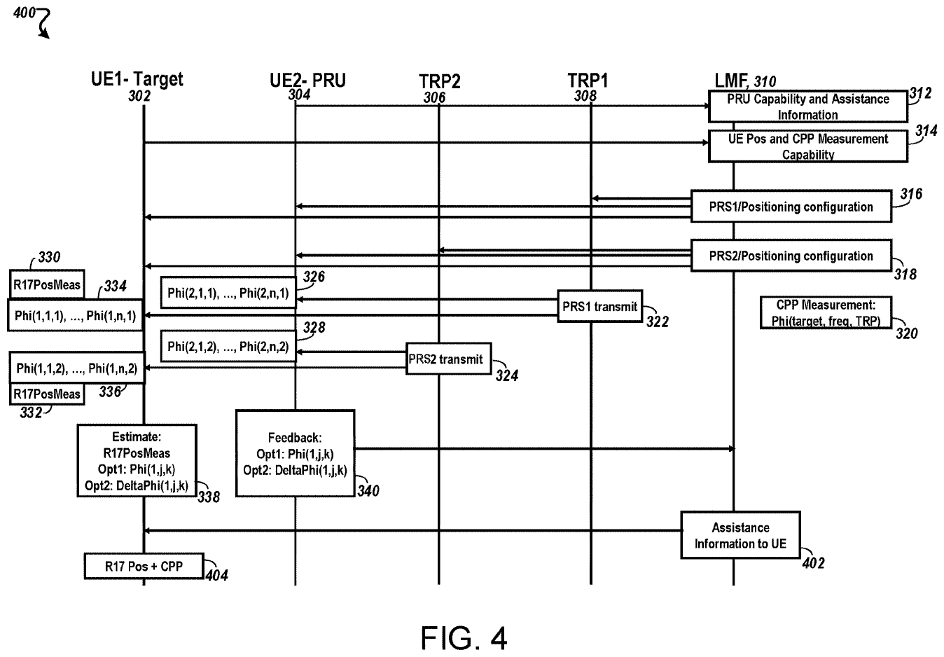

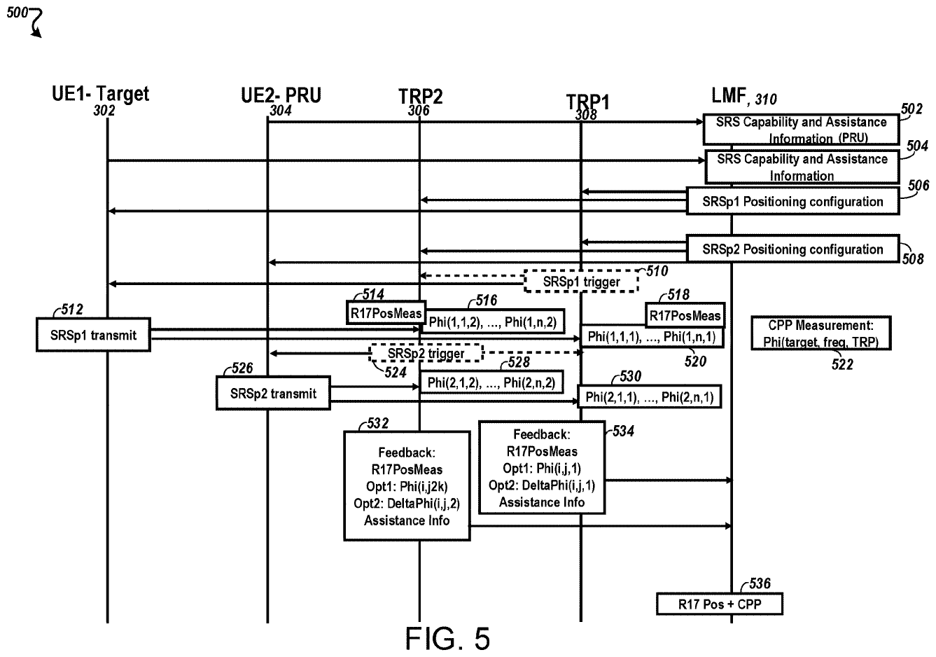

FIGS. 3, 4, and 5 are signal flow diagrams that each illustrate an example process for carrier phase positioning based on the configuration data previously described. In each of the processes 300, 400, and 500 shown in the respective signal flow diagrams of FIG. 3, FIG. 4, and FIG. 5, a device (e.g., the UE or the LMF) is configured to perform carrier phase positioning. For clarity of presentation, the description that follows generally describes methods 300, 400, and 500 in the context of the other figures in this description. For example, the processes 300, 400, and 500 can be performed by the network 100 of FIG. 1. As previously described, a positioning reference unit (PRU) facilitates NR carrier phase positioning. For DL NR carrier phase positioning, the PRU works as a UE to receive the DL PRS reference signals and provide the DL carrier phase measurements to the LMF. At the LMF, the double differential measurements are obtained by determining a difference between the DL carrier phase measurements from the target UE and the carrier phase measurements from the PRU. The difference is used to determine measurement errors and eliminate them. For UL NR carrier phase positioning, the PRU works as a UE to transmit the UL SRS signals for positioning purpose. The TRPs provides the UL carrier phase measurements obtained from the UL SRS signals of the target UE and of the PRU to the LMF. At the LMF, the double differential measurements can be obtained by the difference between the UL carrier phase measurements from the target UE and the carrier phase measurements from the PRU. The difference is used to determine measurement errors and eliminate them. The estimating device (e.g., a UE, TRP, LMF, etc.) performs DL or UL CPP by performing actions for each of processes 300, 400, and 500 as follows.

A first UE (target) and a second UE (UE-PRU) are configured to measure a same PRS. To enable simultaneous measurements on same DL PRS by a target UE and a PRU, the following functions are supported. The UE enables LMF to request the UEs, including target UE and PRU(s), to perform measurements on (indicated) DL PRS resources occurring within indicated time window(s). The timing windows, are for simultaneous PRS measurements in Rel-18, are applicable for UE in RRC_CONNECTED, RRC_INACTIVE, and RRC_IDLE states.

FIG. 3 shows a signal flow diagram including a process 300 for LMF-based DL NR carrier phase positioning. The signal diagram shows a network including a UE1 (target) 302, a UE2 (PRU), a TRP2 306, a TRP 1 308, and an LMF 310. In this example, dual differential CPP is performed at the LMF 310.

The UE2 PRU 304 is configured to signal PRU capability and assistance information 312. The PRU capability and assistance information is previously described in relation to FIG. 2. For example, the PRU capability information describes an indication of configuration supported by the UE for being the PRU, an actual position (possibly with error estimate of position) of the UE, and accuracy measures such as a position accuracy, a CPP accuracy, and an RSPP of path for position measurement. The target UE1 302 signals its position and CPP measurement capability data 314 as previously described in relation to FIG. 2. For example, the target UE 302 signals a capability to support a DL carrier phase positioning based on CP measurements or a capability to support a combination of NR carrier phase positioning with a legacy positioning method, and so forth.

Once the capability information is received at the LMF 310, the LMF 310 generates data specifying the PRS1/positioning configuration 316 and data specifying the PRS2/positioning configuration 318. The LMF 310 sends the PRS1 configuration data 316 to the TRP1 308 and to the PRU UE 304 that are involved for a first differential measurement. The LMF 310 sends the PRS2 configuration data 318 to the TRP2 306 and to the target UE 302 that are involved for a second differential measurement. The LMF 310 thus configures the PRS for each of the other devices in the network for performing the PRS transmissions.

Once the PRSs are configured, the system perform measurements 320. For performance of the CPP estimation, the TRP1 transmits PRS1 data 322 and the PRS2 data 324 to each of the target UE 302 and to the PRU UE 304 at the correct configured time for each. The PRU UE 304 and the target UE 302 are each configured to measure the carrier phases Y of the transmissions. The CPP measurements 320 each include the phase p with the target, frequency band, and TRP index data being reported as φ(target, frequency, TRP). Here, the target refers to the UE to which the transmission is being sent (the target UE 302 or the PRU UE 304). The PRU UE 304 performs a first CPP measurement 326 for the PRS1 transmission 322 and a second CPP measurement 328 for the PRS2 transmission 324. The first CPP measurement 328 includes φ(2, 1, and 1), φ(2, n, 1). The second CPP measurement 328 includes φ(2, 1, and 2), φ(2, n, 2). The target UE 302 performs a first CPP measurement 334 for the PRS1 transmission 322 and a second CPP measurement 336 for the PRS2 transmission 324. The first CPP measurement 334 includes φ(1, 1, and 1), φ(1, n, 1). The second CPP measurement 336 includes φ(1, 1, and 2), φ(1, n, 2). The target UE 302 can also perform a first legacy position measurement 330 (e.g., TDOA, DL-AoD, etc.) associated with the first CPP measurement 334 of the target UE. The target UE 302 can also perform a second legacy position measurement 332 (e.g., TDOA, DL-AoD, etc.) associated with the second CPP measurement 336 of the target UE.

The target UE 302 and the PRU UE 304 each generate respective feedback 338, 340 that includes the CPP measurements and legacy position measurements, if applicable. The target UE 302 generates feedback 338 based on the legacy position measurement 330, the first CPP measurement 334, the second legacy position measurement 332, and the second CPP measurement 336. For example, the feedback 338 includes the legacy measurement values and either an absolute phase value of φ(target, freq., TRP index) or a phase value for Δφ including offset values. The PRU UE 302 generates feedback 340 based on the first CPP measurement 326 and the second CPP measurement 328, in addition to the known position value. For example, the feedback 340 includes the position value and either an absolute phase value of φ(target, freq., TRP index) or a phase value for Δφ including offset values.

Each of the target UE 302 and the PRU UE 304 transmit their respective feedback 338, 340 to the LMF 310, which is configured to perform the CPP estimation based on the measured values of φ at each UE. The LMF 310 generates a position estimate 342 including the legacy position measurement and a CPP value, which can refine the estimated position of the target UE.

FIG. 4 shows a signal flow diagram including a process 400 for UE-based DL NR carrier phase positioning. The signal diagram shows a network including a UE1 (target) 302, a UE2 (PRU), a TRP2 306, a TRP 1 308, and an LMF 310. In this example, dual differential CPP is performed at the UE 302.

The UE2 PRU 304 is configured to signal PRU capability and assistance information 312. The PRU capability and assistance information is previously described in relation to FIG. 2. For example, the PRU capability information describes an indication of configuration supported by the UE for being the PRU, an actual position (possibly with error estimate of position) of the UE, and accuracy measures such as a position accuracy, a CPP accuracy, and an RSPP of path for position measurement. The target UE1 302 signals its position and CPP measurement capability data 314 as previously described in relation to FIG. 2. For example, the target UE 302 signals a capability to support a DL carrier phase positioning based on CP measurements or a capability to support a combination of NR carrier phase positioning with a legacy positioning method, and so forth.

Once the capability information is received at the LMF 310, the LMF 310 generates data specifying the PRS1/positioning configuration 316 and data specifying the PRS2/positioning configuration 318. The LMF 310 sends the PRS1 configuration data 316 to the TRP1 308 and to the PRU UE 304 that are involved for a first differential measurement. The LMF 310 sends the PRS2 configuration data 318 to the TRP2 306 and to the target UE 302 that are involved for a second differential measurement. The LMF 310 thus configures the PRS for each of the other devices in the network for performing the PRS transmissions.

Once the PRSs are configured, the system perform measurements 320. For performance of the CPP estimation, the TRP1 transmits PRS1 data 322 and the PRS2 data 324 to each of the target UE 302 and to the PRU UE 304 at the correct configured time for each. The PRU UE 304 and the target UE 302 are each configured to measure the carrier phases Y of the transmissions. The CPP measurements 320 each include the phase p with the target, frequency band, and TRP index data being reported as φ(target, frequency, TRP). Here, the target refers to the UE to which the transmission is being sent (the target UE 302 or the PRU UE 304). The PRU UE 304 performs a first CPP measurement 326 for the PRS1 transmission 322 and a second CPP measurement 328 for the PRS2 transmission 324. The first CPP measurement 328 includes φ(2, 1, and 1), φ(2, n, 1). The second CPP measurement 328 includes φ(2, 1, and 2), φ(2, n, 2). The target UE 302 performs a first CPP measurement 334 for the PRS1 transmission 322 and a second CPP measurement 336 for the PRS2 transmission 324. The first CPP measurement 334 includes φ(1, 1, and 1), φ(1, n, 1). The second CPP measurement 336 includes φ(1, 1, and 2), φ(1, n, 2). The target UE 302 can also perform a first legacy position measurement 330 (e.g., TDOA, DL-AoD, etc.) associated with the first CPP measurement 334 of the target UE. The target UE 302 can also perform a second legacy position measurement 332 (e.g., TDOA, DL-AoD, etc.) associated with the second CPP measurement 336 of the target UE.

The target UE 302 and the PRU UE 304 each generate respective feedback 338, 340 that includes the CPP measurements and legacy position measurements, if applicable. The target UE 302 generates feedback 338 based on the legacy position measurement 330, the first CPP measurement 334, the second legacy position measurement 332, and the second CPP measurement 336. For example, the feedback 338 includes the legacy measurement values and either an absolute phase value of φ(target, freq., TRP index) or a phase value for Δφ including offset values. The PRU UE 302 generates feedback 340 based on the first CPP measurement 326 and the second CPP measurement 328, in addition to the known position value. For example, the feedback 340 includes the position value and either an absolute phase value of φ(target, freq., TRP index) or a phase value for Δφ including offset values.

Once the feedback 338 and 340 are generated by the target UE 302 and the PRU UE 304, the PRU UE sends the feedback 340 to the LMF 310. The feedback can include assistance information, such as the RSRP or of the RSRP of the first path as the assistance information for position estimation. In some implementations, the target UE uses this assistance information of a search range of the integer ambiguity, as previously described. The LMF 310 receives the feedback 340 and generates assistance data 402 that is sent to the target UE 302. The target UE 302 then generates the position estimate 404 including the CPP estimate and legacy position estimate. As previously stated, the CPP estimate can refine the legacy position estimate for the position estimate 404 to sub-meter (centimeter) precision.

FIG. 5 shows a signal flow diagram including a process 500 for LMF-based UL NR carrier phase positioning. The signal diagram shows a network including a UE1 (target) 302, a UE2 (PRU), a TRP2 306, a TRP 1 308, and an LMF 310. In this example, dual differential CPP is performed at the LMF 310. In this example, position measurements are processed at the TRP2 306 and the TRP1 308. For UL NR CPP, each of the target UE 302 and the PRU UE 304 send respective SRS capability and assistance information to the LMF 310. The data in the SRS capability and assistance information transmissions 502, 504 as described previously in relation to FIG. 2. For example, target UE 302 sends SRS capability and assistance information 504 to the LMF 310, and PRU UE 304 sends the SRS capability and assistance information 506 to the LMF 310.

The LMF 310 generates SRS positioning configuration data for each of the target UE 302 and the PRU UE 304. For example, the LMF 310 generates SRSp1 positioning and configuration data 506 for sending to the TRP2 306 and the target UE 302. For example, the LMF 310 generates SRSp2 positioning and configuration data 508 for sending to the TRP1 306 and the PRU UE 304.

Each of the TRP1 308 and the TRP2 306 triggers a position measurement at a configured time. The TRP1 308 generates a SRSp1 trigger 510 and sends the trigger to the target UE 302 and the TRP2 306. The target UE 302 is triggered to send the SRSp1 transmission 512 to the TRP2 306 and the TRP1 308. The TRP2 306 performs a CPP measurement 522 reported as φ(target, frequency, TRP), where y represents the CP and the target, frequency, and TRP are represented as indexes. The TRP2 generates CPP measurement 516 specifying φ(1, 1, 2), φ(1, n, 2) based on the SRSp2 transmission 512. The TRP2 306 performs a legacy position measurement 514 based on the SRSp1 transmission 512. Similarly, the TRP1 308 generates a CPP measurement 520 specifying φ(1, 1, 1), φ(1, n, 1) and a legacy position measurement 518 based on the SRSp1 transmission 512.

The TRP2 306 generates a SRSp2 trigger 524 and sends the trigger to the PRU UE 304 and the TRP1 308. The PRU UE 304 is triggered to send the SRSp2 transmission 526 to the TRP2 306 and the TRP1 308. The TRP2 306 performs a CPP measurement 528 reported as φ(target, frequency, TRP), where p represents the CP and the target, frequency, and TRP are represented as indexes. The TRP2 generates CPP measurement 528 specifying φ(2, 1, 2), φ(2, n, 2) based on the SRSp2 transmission 526. Similarly, the TRP1 308 generates a CPP measurement 530 specifying φ(2, 1, 1), φ(2, n, 1) based on the SRSp2 transmission 526.

The TRP2 306 generates feedback 532 based on the generated legacy measurement data 514 from the SRSp1 of the target UE 302, CPP measurement data 528 from the SRSp2 of the PRU UE 304, and CPP measurement data 516 from the SRSp1 of the target UE 302. Similarly, the TRP1 308 generates feedback 534 based on the generated legacy measurement data 518 from the SRSp1 of the target UE 302, CPP measurement data 530 from the SRSp2 of the PRU UE 304, and CPP measurement data 518 from the SRSp1 of the target UE 302. The feedback data 532 includes the position value and either an absolute phase value of φ(target, freq., TRP index) or a phase value for Δφ including offset values for the target UE 302. The feedback 532 can include assistance information, such as the RSRP or of the RSRP of the first path as the assistance information for position estimation. Similarly, the feedback data 534 includes the position value and either an absolute phase value of φ(target, freq., TRP index) or a phase value for Δφ including offset values for the target UE 302. The feedback 534 can include assistance information, such as the RSRP or of the RSRP of the first path as the assistance information for position estimation.

The feedback data 532 from the TRP2 306 and the feedback data 534 from the TRP1 308 are sent to the LMF 310. The LMF 310 is configured to perform the dual differential CPP estimate. The LMF 310 generates the position estimate 536 based on the CPP estimate and the legacy position estimate. As previously stated, the CPP estimate can refine the legacy position estimate for the position estimate 536 to sub-meter (centimeter) precision.

To enable simultaneous transmission of UL SRS for positioning by a target UE and a PRU, the system supports the following features. The LMF can request the serving base station (gNB) of a UE to configure the transmission of the (indicated) UL SRS resources from the UE within indicated time window(s). In an aspect, The LMF is configured to request the serving base station and neighboring base stations of the UE to measure the (indicated) UL SRS resources from the UE within indicated time window(s). This may be a different indicated time window.

Each of the processes 300, 400, and 500 shows a combination of an NR carrier phase positioning measurement with a legacy positioning method such as DL-TDOA, UL-TDOA, Multi-RTT, etc. For example, for each process 300, 400, and 500, the PRS capability transmissions can specify that a respective UE indicates capability to perform stand-alone CPP or CPP combined with other legacy positioning methods. For example, the PRS capability transmissions can specify that a respective UE indicates capability to generate additional assistance information, such as an integer ambiguity range (if using X), a number of frequency measurements (if using multi-frequency), and RSRPP (for scaling factor if using multi-frequency). For each process 300, 400, and 500, the positioning configuration data indicates a configuration of PRS/SRSp that is received or transmitted by the target UE and PRU UE. For each process 300, 400, and 500, the positioning configuration data indicates the measurements that are needed for position estimation including legacy position measurements and carrier phase measurements. The positioning configuration data indicates a type of report for being transmitted to or from the LMF or UE. The positioning configuration data indicates that the UE2 is adopt role as the PRU as previously described and that there can be feedback of assistance information from the UE2. For the respective processes 300, 400, and 500, the SPS trigger, CPP measurement, and feedback data can include the following. For UL CPP process 500, if aperiodic SPSs are configured, a downlink control information (DCI) trigger indicates which UE should transmit to which TRPs. These data can specify a gNB-to-gNB connection or measurement gap configured to setup a TRP for measurement. In some implementations, a measurement is added to feedback for each legacy method only for the target UE 302. In some implementations, there is a separate feedback information element (IE) for the CPP. The IE is included as the feedback if CPP is enabled.

The signaling for joint and standalone CPP includes data as shown in the subsequent tables. For example, each of the tables shows a list of information or measurement results. The PRU may transmit location coordinates and position accuracy. For PRU feedback, only CP measurements are needed. Assistance data can be provided on a search space for integer ambiguity calculation, as previously described. For each of Tables 1-9, for standalone CPP, only the marked portions of the data are transmitted.

Table 1 shows measurement results for joint-multi-RTT positioning. The measurement results can be transmitted from the UE 302, 304 to the LMF 310.

Information

PCI, GCI, and PRS ID, ARFCN, PRS resource ID, PRS
resource set ID for each measurement
DL-PRS-RSRP measurement
UE Rx-Tx time difference measurement
Time stamp of measurement
Quality for each measurement
TA offset used by UE
UE Rx TEG IDs, UE Tx TEG IDs, and UE RxTx TEG IDs
associated with UE Rx-Tx time difference measurements
LOS/NLOS information for UE measurements
DL-PRS-RSRPP measurement
The association of UE Tx TEG ID and SRS
N carrier phase measurement ^{NOTE 1}
Optional: ToA measurement
NOTE 1: when used with Carrier phase positioning

Table 2 shows measurement results for joint-multi-RTT positioning. The measurement results can be transmitted from a base station (e.g., base station 104 of FIG. 1) to the LMF 310.

Measurement Results

NCGI and TRP ID of the measurement
gNB Rx-Tx time difference measurement
UL-SRS-RSRP
UL-SRS-RSRPP
U Angle of Arrival (azimuth and/or elevation)^{NOTE 1}
Multiple UL Angle of arrival (azimuth and/or
elevation) NOTE 1
SRS Resource Type ^{NOTE 1}
Time stamp of the measurement
Quality for each measurement
Beam information for each measurement
LoS/NLOS information for each measurement
ARP ID of the measurement
NOTE 1: When used with UL-AoA for hybrid positioning.
N carrier phase measurements ^{NOTE 2}
Optional: ToA measurement ^{NOTE 2}
Note 2: when used with carrier phase positioning

Table 3 shows example assistance data that may be transferred from the LMF 310 to the UE 302, 304.

Information

Physical cell IDs (PCIs), global cell IDs (GCIs), and PRS IDs, ARFCNs of
candidate NR TRPs for measurement
Timing relative to the serving (reference) TRP of candidate NR TRPs
DL-PRS configuration of the TRPs (the time/frequency occupancy of
SSBs)
PRS-only TP indication
On-Demand DL-PRS-Configurations
Validity Area of Assistance Data
Number of Carrier phases to be measured per PRS bandwidth
Carrier phase supported

Table 4 shows example measurement request data that may be transmitted from the LMF 310 to one or more base stations (gNBs).

Information

TRP ID, and NCGI of the TRP to receive UL-SRS
UE-SRS configuration
UL timing information together with timing uncertainty,
for reception of SRS by candidate TRPs
Report characteristics for the measurements
Measurement Quantities
Measurement periodicity
Measurement beam information request
Search window information
Expected UL AoA/ZoA and uncertainty range
Number of TRP Rx TEGs
Number of TRP RxTx TEGs
Response time
Measurement characteristics request indicator
Measurement time occasions for a measurement instance
Number of CPs required per SRS bandwidth

Example data for signaling for joint and standalone CPP and DL-TDoA are now described. The PRU can transmit location coordinates and position accuracy. Assistance data can be provided on search space for determination of the integer ambiguity.

Table 5 shows example assistance data for joint and standalone CPP-DL-TDoA. The assistance data may be transmitted from the LMF 310 to the UE 302, 304.

| | UE- | |
|---|---|---|
| Information | assisted | UE-based |
| Physical cell IDs (PCIs), global cell IDs (GCIs), and PRS IDs, | Yes | Yes |
| ARFCNs of candidate NR TRPs for measurement | | |
| Timing relative to the serving (reference) TRP of candidate NR TRPs | Yes | Yes |
| DL-PRS configuration of the TRPs (the time/frequency occupancy | Yes | Yes |
| of SSBs) | | |
| SSB information of the TRPs (the time/frequency occupancy of | Yes | Yes |
| SSBs) | | |
| Spatial direction information (e.g. azimuth, elevation, etc.) of the | No | Yes |
| DL-PRS resources of the TRPs served by the gNB | | |
| Geographical coordinates of the TRPs served by the gNB (include a | No | Yes |
| transmission reference location for each DL-PRS Resource ID, | | |
| reference location for the transmitting antenna of the reference TRP, | | |
| relative locations for transmitting antennas of other TRPs) | | |
| Fine Timing relative to the serving (reference) TRP of candidate NR | No | Yes |
| TRPs | | |
| PRS-only TP indication | Yes | Yes |
| The association information of DL-PRS resources with TRP Tx TEG | No | Yes |
| ID | | |
| LOS/NLOS indicators | No | Yes |
| On-Demand DL-PRS-Configurations | Yes | Yes |
| Validity Area of the Assistance Data | Yes | Yes |
| Number of carrier phases to be measured per PRS | Yes | No |
| Carrier Phase supported | Yes | No |

Table 6 shows measurement results for joint and standalone CPP-DL-TDoA. The measurement results can be transmitted from a UE 302, 304 to the LMF 310.

| | UE- | UE- |
|---|---|---|
| Information | assisted | based |
| Latitude/Longitude/Altitude, together with | No | Yes |
| uncertainty shape | | |
| PCI, GCI, ARFCN, PRS resource ID, PRS | Yes | No |
| resource set IS and PRS ID for each measurement | | |
| DL RSTD measurement | Yes | No |
| DL-PRS-RSRP measurement | Yes | No |
| Time stamp of the measurements | Yes | No |
| Time stamp of location estimate | Yes | Yes |
| Quality for each measurement | Yes | No |
| UE Rx TEG IDs for DL RSTD measurements | Yes | No |
| DL-PRS-RSRPP measurement | Yes | No |
| LOS/NLOS information for UE measurements | Yes | No |
| N Carrier Phase measurements | Yes | No |
| Optional: ToA measurements | Yes | No |

Example data for signaling for joint and standalone CPP and UL-TDoA are now described. The assistance data on search space can be provided for integer ambiguity determination. For PRU feedback, only CP feedback is needed from the LUE 304.

Table 7 shows UE configuration data for signaling for joint and Standalone CPP-UL-TDoA. The measurement results can be transmitted from a base station (e.g., base station 104 of FIG. 1) to the LMF 310.

UE configuration data

UE SRS configuration
Timing information of the TRP, which configured the UE SRS
transmission
The association information of SRS resources with UE Tx TEG ID
Number of Carrier Phases to be measured per PRS bandwidth
Carrier phase supported

Table 8 shows measurement results for signaling for joint and Standalone CPP-UL-TDoA. The measurement results can be transmitted from a base station (e.g., base station 104 of FIG. 1) to the LMF 310.

Measurement Results
Measurement Results

NCGI and TRP ID of the measurement
UL-RTOA
UL-SRS-RSRP
UL-SRS-RSRPP
UL Angle of Arrival (azimuth and/or elevation) NOTE 1
SRS Resource Type NOTE 1
Time stamp of the measurement
Quality for each measurement
Beam information for each measurement
LoS/NLOS information for each measurement
ARP ID of the measurement
NOTE 1: When used with UL-AoA for hybrid positioning.
N carrier phase measurements ^{NOTE 2}
Optional: ToA measurement ^{NOTE 2}
NOTE 2: when used with Carrier phase positioning

Table 9 shows measurement request information for joint and Standalone CPP-UL-TDoA. The measurement results can be transmitted from the LMF 310 to a base station (e.g., base station 104 of FIG. 1) to the LMF 310.

Information

TRP ID, cell ID of the TRP to receive UL-SRS
UE-SRS configuration
UL timing information together with timing uncertainty,
for reception of SRS by candidate TRPs
Report characteristics for the measurements
Measurement Quantities
Measurement periodicity
Measurement beam information request
Search window information
Expected UL AoA/ZoA and uncertainty range
Number of TRP Rx TEGs
Response time
Measurement characteristics request indicator
Measurement time occasions for a measurement instance
Measurement of the N carrier phases
TRP ID, cell ID of the TRP to receive UL-SRS

CPP indication and feedback for multipath channels is now described. Multipath/NLOS impacts NR carrier phase positioning as follows. Multipath/NLOS deteriorates the performance of carrier phase positioning. Multipath mitigation is considered for NR carrier phase positioning. Carrier phase positioning may fail in multipath channels. To resolve this issue, CPP indication and feedback are provided. For example, to ensure good performance in multipath/NLOS channels, CPP can be disabled in a NLOS channel. For LMF-based CP, the UE/TRP sends LOS/NLOS channel assistance information to the LMF. In some implementations, single flag indication is used or not used based on LOS/NLOS. In some implementations, a probability of LOS/NLOS channel is provided. In some implementations, the LOS/NLOS probability of each tap is provided, with feedback of C. For UE-based CP, a flag is used to indicate that CPP is performed or not based on LOS/NLOS properties. For the feedback of CP, the UE or TRP sends CP of the first path only.

CP-PRS design is now described. A waveform is designed to facilitate the signal generation at multiple sub-bands. For example, a CP sub-band includes multiple REs in the frequency domain and over one or more OFDM symbol in the time domain. The CP sub-bands are of the same multiple Res. In some implementations, a variation in which the CP sub-bands are different is also possible. There can be “guard REs” or “guard tones” between two adjacent CP sub-bands. A benefit of introducing guard REs is a simplified receiver design. This is because matched filtering at different CP sub-bands can be performed. In some implementations, the number of “guard REs” may be constant. The CP measurement results may be processed by the UE. The processed result is reported as feedback to the network. In some implementations, alternatively, the CP measurement results are reported as feedback by the UE, and the network processes the CP measurement results. In this case, the “guard REs” unequal. Because the LMF handles the processing, the processing can be as complicated as the LMF can handle. In some implementations, a signaling design between the RAN and LMF and the UE is configured to align the CP measurement and reporting so that the LMF can process the CP report from the UE.

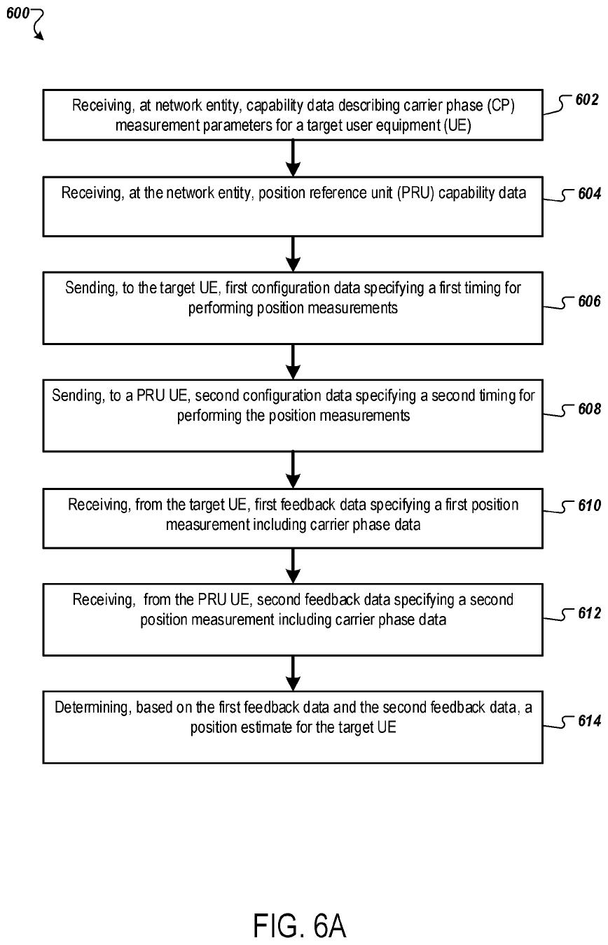

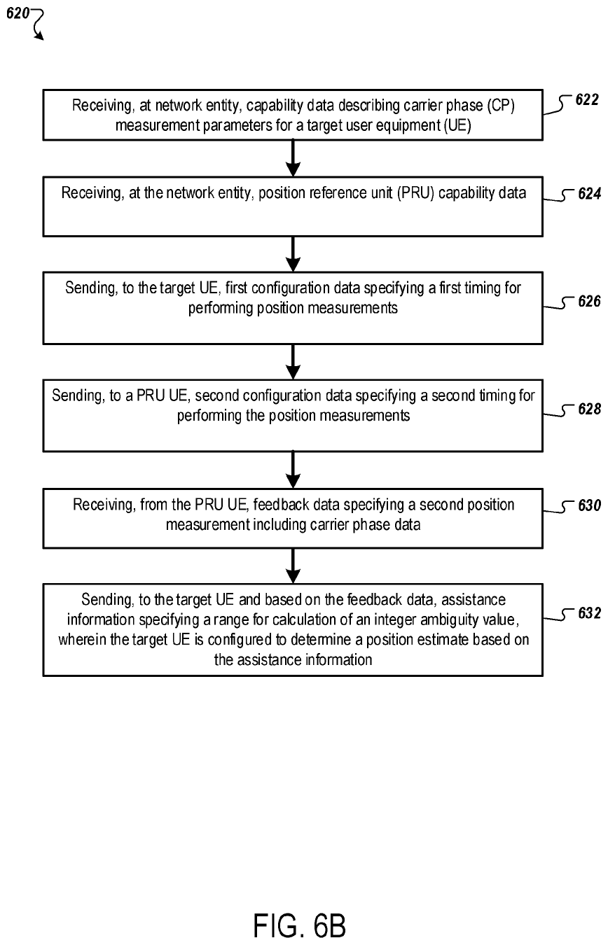

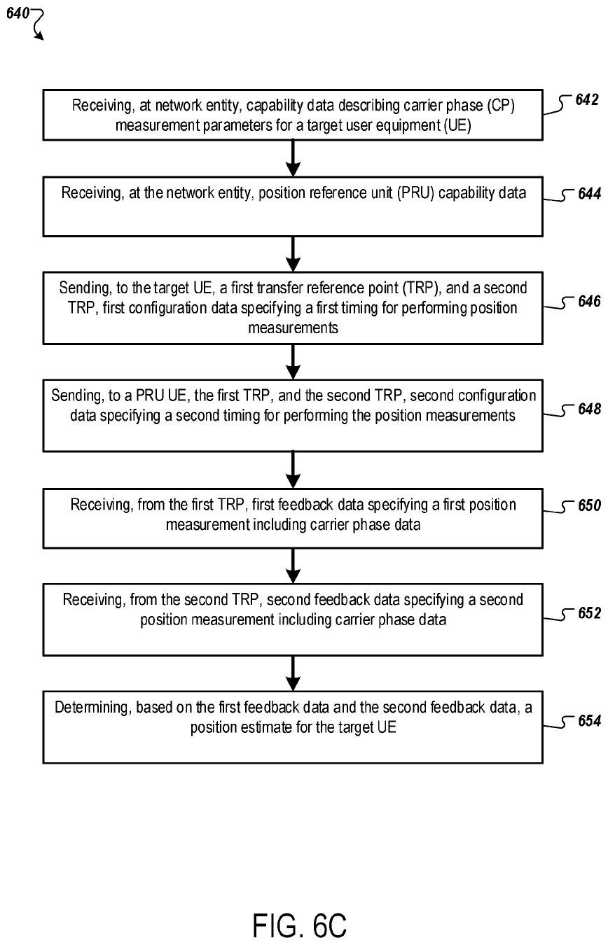

FIG. 6A illustrates a flowchart of an example method 600, according to some implementations. For clarity of presentation, the description that follows generally describes method 600 in the context of the other figures in this description. For example, method 600 can be performed by a LMF of FIGS. 3-5. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

The method 600 includes receiving (602), at network entity, capability data describing carrier phase (CP) measurement parameters for a target user equipment (UE). The method 600 includes receiving (604), at the network entity, position reference unit (PRU) capability data. The method 600 includes sending (606), to the target UE, first configuration data specifying a first timing for performing position measurements. The method 600 includes sending (608), to a PRU UE, second configuration data specifying a second timing for performing the position measurements. The method 600 includes receiving (610), from the target UE, first feedback data specifying a first position measurement including carrier phase data. The method 600 includes receiving (612), from the PRU UE, second feedback data specifying a second position measurement including carrier phase data. The method 600 includes determining (614), based on the first feedback data and the second feedback data, a position estimate for the target UE.

In some implementations, the capability data specifies that the target UE is configured to support multi-frequency based CPP estimation. In some implementations, the multi-frequency based CPP estimation is based on a virtual frequency. In some implementations, the capability data specifies that the target UE is configured to support a single frequency based CPP estimation. In some implementations, the multi-frequency based CPP estimation is based on a multi-hypothesis integer ambiguity estimation.

In some implementations, the capability data specifies that the target UE is configured to support a combination of CPP measurement and at least one of downlink time of arrival (DL-TDOA) position measuring, uplink time difference of arrival (UL-TDOA) position measuring, and multi-round trip time (RTT) position measuring. In some implementations, the capability data specifies that the target UE is configured to support the combination for simultaneous processing of the CPP measurement at the at least one of the DL-TDOA position measuring, the UL-TDOA position measuring, and the multi-RTT position measuring.

In some implementations, the capability data specifies that the target UE is configured to support standalone CPP only. In some implementations, the capability data specifies that the target UE is configured to support double differential CPP. In some implementations, the capability data specifies that the target UE is configured to support a single CP measurement across multiple position frequency layers (PFLs) simultaneously. In some implementations, the capability data specifies that the target UE is configured to support a single carrier phase measurement across multiple PFLs simultaneously with a time of arrival (TOA) estimation. In some implementations, the capability data specifies that the target UE is configured to support a specified number of CP measurements across PFLs simultaneously. In some implementations, the capability data specifies that the target UE is configured to support a specified number of CP measurements across PFLs sequentially. In some implementations, the capability data specifies that the target UE is configured to support a specified number of position measurement occasions with a CPP measurement occasion in one or more report occasions.

In some implementations, the capability data specifies that the target UE is configured to associate a specified number of CPP measurement occasions with a position measurement occasion in one or more report occasions.

In some implementations, the capability data specifies that the target UE is configured to process a first number of DL PRS symbols in a period of time at a given periodicity for a given maximum bandwidth. In some implementations, the capability data specifies that the target UE is configured to process a CPP based on a first offset value for the first number of DL PRS symbols and based on a second offset value for the given periodicity.

FIG. 6B illustrates a flowchart of an example method 620, according to some implementations. For clarity of presentation, the description that follows generally describes method 620 in the context of the other figures in this description. For example, method 620 can be performed by a LMF of FIGS. 3-5. It will be understood that method 620 can be performed, for example, by any suitable system, environment, software, hardware, or a combination of systems, environments, software, and hardware, as appropriate. In some implementations, various steps of method 620 can be run in parallel, in combination, in loops, or in any order.

The method 620 includes receiving (622), at network entity, capability data describing carrier phase (CP) measurement parameters for a target user equipment (UE). The method 620 includes receiving (624), at the network entity, position reference unit (PRU) capability data. The method 620 includes sending (626), to the target UE, first configuration data specifying a first timing for performing position measurements. The method 620 includes sending (628), to a PRU UE, second configuration data specifying a second timing for performing the position measurements. The method 620 includes receiving (630), from the PRU UE, feedback data specifying a second position measurement including carrier phase data. The method 620 includes sending (632), to the target UE and based on the feedback data, assistance information specifying a range for calculation of an integer ambiguity value, wherein the target UE is configured to determine a position estimate based on the assistance information.

In some implementations, the capability data specifies that the target UE is configured to support multi-frequency based CPP estimation. In some implementations, the multi-frequency based CPP estimation is based on a virtual frequency. In some implementations, the capability data specifies that the target UE is configured to support a single frequency based CPP estimation. In some implementations, the multi-frequency based CPP estimation is based on a multi-hypothesis integer ambiguity estimation.

In some implementations, the capability data specifies that the target UE is configured to support a combination of CPP measurement and at least one of downlink time of arrival (DL-TDOA) position measuring, uplink time difference of arrival (UL-TDOA) position measuring, and multi-round trip time (RTT) position measuring. In some implementations, the capability data specifies that the target UE is configured to support the combination for simultaneous processing of the CPP measurement at the at least one of the DL-TDOA position measuring, the UL-TDOA position measuring, and the multi-RTT position measuring.

In some implementations, the capability data specifies that the target UE is configured to support standalone CPP only. In some implementations, the capability data specifies that the target UE is configured to support double differential CPP. In some implementations, the capability data specifies that the target UE is configured to support a single CP measurement across multiple position frequency layers (PFLs) simultaneously. In some implementations, the capability data specifies that the target UE is configured to support a single carrier phase measurement across multiple PFLs simultaneously with a time of arrival (TOA) estimation. In some implementations, the capability data specifies that the target UE is configured to support a specified number of CP measurements across PFLs simultaneously. In some implementations, the capability data specifies that the target UE is configured to support a specified number of CP measurements across PFLs sequentially. In some implementations, the capability data specifies that the target UE is configured to support a specified number of position measurement occasions with a CPP measurement occasion in one or more report occasions.

In some implementations, the capability data specifies that the target UE is configured to associate a specified number of CPP measurement occasions with a position measurement occasion in one or more report occasions.

In some implementations, the capability data specifies that the target UE is configured to process a first number of DL PRS symbols in a period of time at a given periodicity for a given maximum bandwidth. In some implementations, the capability data specifies that the target UE is configured to process a CPP based on a first offset value for the first number of DL PRS symbols and based on a second offset value for the given periodicity.

FIG. 6C illustrates a flowchart of an example method 640, according to some implementations. For clarity of presentation, the description that follows generally describes method 640 in the context of the other figures in this description. For example, method 640 can be performed by a LMF of FIGS. 3-5. It will be understood that method 640 can be performed, for example, by any suitable system, environment, software, hardware, or a combination of systems, environments, software, and hardware, as appropriate. In some implementations, various steps of method 640 can be run in parallel, in combination, in loops, or in any order.

The method 640 includes receiving (642), at network entity, capability data describing carrier phase (CP) measurement parameters for a target user equipment (UE). The method 640 includes receiving (644), at the network entity, position reference unit (PRU) capability data. The method 640 includes sending (646), to the target UE, a first transfer reference point (TRP), and a second TRP, first configuration data specifying a first timing for performing position measurements. The method 640 includes sending (648), to a PRU UE, the first TRP, and the second TRP, second configuration data specifying a second timing for performing the position measurements. The method 640 includes receiving (650), from the first TRP, first feedback data specifying a first position measurement including carrier phase data. The method 640 includes receiving (652), from the second TRP, second feedback data specifying a second position measurement including carrier phase data. The method 640 includes determining (654), based on the first feedback data and the second feedback data, a position estimate for the target UE.

In some implementations, the capability data specifies that the target UE is configured to support multi-frequency based CPP estimation. In some implementations, the multi-frequency based CPP estimation is based on a virtual frequency. In some implementations, the capability data specifies that the target UE is configured to support a single frequency based CPP estimation. In some implementations, the multi-frequency based CPP estimation is based on a multi-hypothesis integer ambiguity estimation.

In some implementations, the capability data specifies that the target UE is configured to support a combination of CPP measurement and at least one of downlink time of arrival (DL-TDOA) position measuring, uplink time difference of arrival (UL-TDOA) position measuring, and multi-round trip time (RTT) position measuring. In some implementations, the capability data specifies that the target UE is configured to support the combination for simultaneous processing of the CPP measurement at the at least one of the DL-TDOA position measuring, the UL-TDOA position measuring, and the multi-RTT position measuring.

In some implementations, the capability data specifies that the target UE is configured to support standalone CPP only. In some implementations, the capability data specifies that the target UE is configured to support double differential CPP. In some implementations, the capability data specifies that the target UE is configured to support a single CP measurement across multiple position frequency layers (PFLs) simultaneously. In some implementations, the capability data specifies that the target UE is configured to support a single carrier phase measurement across multiple PFLs simultaneously with a time of arrival (TOA) estimation. In some implementations, the capability data specifies that the target UE is configured to support a specified number of CP measurements across PFLs simultaneously. In some implementations, the capability data specifies that the target UE is configured to support a specified number of CP measurements across PFLs sequentially. In some implementations, the capability data specifies that the target UE is configured to support a specified number of position measurement occasions with a CPP measurement occasion in one or more report occasions.

In some implementations, the capability data specifies that the target UE is configured to associate a specified number of CPP measurement occasions with a position measurement occasion in one or more report occasions.

In some implementations, the capability data specifies that the target UE is configured to process a first number of DL PRS symbols in a period of time at a given periodicity for a given maximum bandwidth. In some implementations, the capability data specifies that the target UE is configured to process a CPP based on a first offset value for the first number of DL PRS symbols and based on a second offset value for the given periodicity.

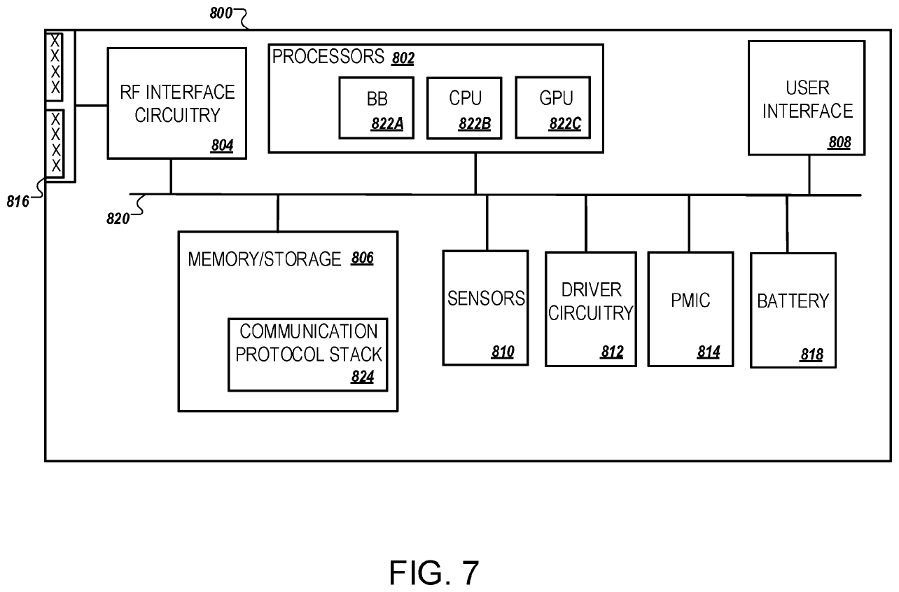

FIG. 7 illustrates an example UE 800, according to some implementations. The UE 800 may be similar to and substantially interchangeable with UE 102 of FIG. 1.

The UE 800 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 800 may include processors 802, RF interface circuitry 804, memory/storage 806, user interface 808, sensors 810, driver circuitry 812, power management integrated circuit (PMIC) 814, one or more antenna(s) 816, and battery 818. The components of the UE 800 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 820, which may represent any type of interface, input/output, bus (local, system, or expansion), transmission line, trace, optical connection, etc. that allows various circuit components (on common or different chips or chipsets) to interact with one another.

The processors 802 may include processor circuitry such as, for example, baseband processor circuitry (BB) 822A, central processor unit circuitry (CPU) 822B, and graphics processor unit circuitry (GPU) 822C. The processors 802 may include any type of circuitry or processor circuitry that executes or otherwise operates computer-executable instructions, such as program code, software modules, or functional processes from memory/storage 806 to cause the UE 800 to perform operations as described herein.

In some implementations, the baseband processor circuitry 822A may access a communication protocol stack 824 in the memory/storage 806 to communicate over a 3GPP compatible network. In general, the baseband processor circuitry 822A may access the communication protocol stack to perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 804. The baseband processor circuitry 822A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 806 may include one or more non-transitory, computer-readable media that includes instructions (for example, communication protocol stack 824) that may be executed by one or more of the processors 802 to cause the UE 800 to perform various operations described herein. The memory/storage 806 include any type of volatile or non-volatile memory that may be distributed throughout the UE 800. In some implementations, some of the memory/storage 806 may be located on the processors 802 themselves (for example, L1 and L2 cache), while other memory/storage 806 is external to the processors 802 but accessible thereto via a memory interface. The memory/storage 806 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 804 may include transceiver circuitry and radio frequency front module (RFEM) that allows the UE 800 to communicate with other devices over a radio access network. The RF interface circuitry 804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 816 and proceed to filter and amplify (with a low-noise amplifier) the signal. The signal may be provided to a receiver of the transceiver that downconverts the RF signal into a baseband signal that is provided to the baseband processor of the processors 802.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 816. In various implementations, the RF interface circuitry 804 may be configured to transmit/receive signals in a manner compatible with NR access technologies.

The antenna(s) 816 may include one or more antenna elements to convert electrical signals into radio waves to travel through the air and to convert received radio waves into electrical signals. The antenna elements may be arranged into one or more antenna panels. The antenna(s) 816 may have antenna panels that are omnidirectional, directional, or a combination thereof to enable beamforming and multiple input, multiple output communications. The antenna(s) 816 may include microstrip antennas, printed antennas fabricated on the surface of one or more printed circuit boards, patch antennas, phased array antennas, etc. The antenna(s) 816 may have one or more panels designed for specific frequency bands including bands in FR1 or FR2.

The user interface 808 includes various input/output (I/O) devices designed to enable user interaction with the UE 800. The user interface 808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 810 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 812 may include software and hardware elements that operate to control particular devices that are embedded in the UE 800, attached to the UE 800, or otherwise communicatively coupled with the UE 800. The driver circuitry 812 may include individual drivers allowing other components to interact with or control various input/output (I/O) devices that may be present within, or connected to, the UE 800. For example, driver circuitry 812 may include a display driver to control and allow access to a display device, a touchscreen driver to control and allow access to a touchscreen interface, sensor drivers to obtain sensor readings of sensors 810 and control and allow access to sensors 810, drivers to obtain actuator positions of electro-mechanic components or control and allow access to the electro-mechanic components, a camera driver to control and allow access to an embedded image capture device, audio drivers to control and allow access to one or more audio devices.

The PMIC 814 may manage power provided to various components of the UE 800. In particular, with respect to the processors 802, the PMIC 814 may control power-source selection, voltage scaling, battery charging, or DC-to-DC conversion.

In some implementations, the PMIC 814 may control, or otherwise be part of, various power saving mechanisms of the UE 800. A battery 818 may power the UE 800, although in some examples the UE 800 may be mounted deployed in a fixed location and may have a power supply coupled to an electrical grid. The battery 818 may be a lithium ion battery, a metal-air battery, such as a zinc-air battery, an aluminum-air battery, a lithium-air battery, and the like. In some implementations, such as in vehicle-based applications, the battery 818 may be a typical lead-acid automotive battery.

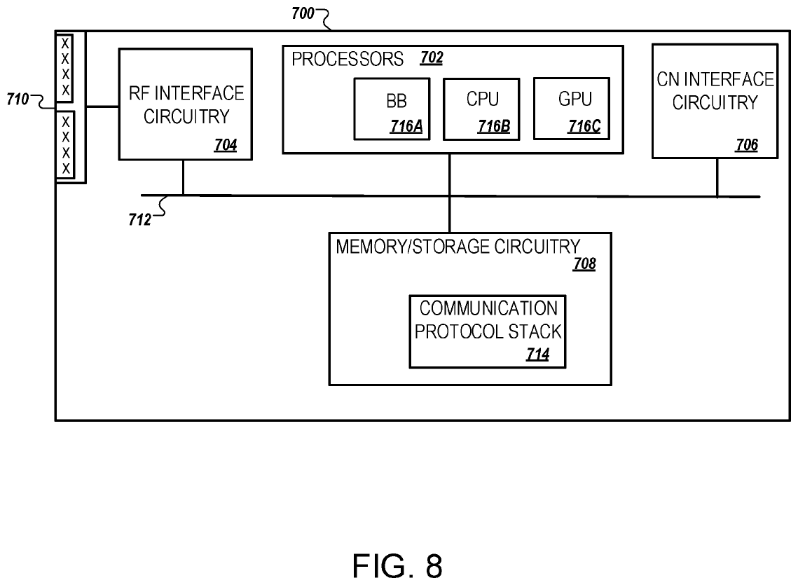

FIG. 8 illustrates an example access node 700 (e.g., a base station or gNB), according to some implementations. The access node 700 may be similar to and substantially interchangeable with base station 104. The access node 700 may include processors 702, RF interface circuitry 704, core network (CN) interface circuitry 706, memory/storage circuitry 708, and one or more antenna(s) 710.

The components of the access node 700 may be coupled with various other components over one or more interconnects 712. The processors 702, RF interface circuitry 704, memory/storage circuitry 708 (including communication protocol stack 714), antenna(s) 710, and interconnects 712 may be similar to like-named elements shown and described with respect to FIG. 7. For example, the processors 702 may include processor circuitry such as, for example, baseband processor circuitry (BB) 716A, central processor unit circuitry (CPU) 716B, and graphics processor unit circuitry (GPU) 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In V2X scenarios, the access node 700 may be or act as a “Roadside Unit.” The term “Roadside Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Although the embodiments above have been described in considerable detail, numerous variations and modifications will become apparent to those skilled in the art once the above disclosure is fully appreciated. It is intended that the following claims be interpreted to embrace all such variations and modifications.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, and exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

Proposals described herein include the following. Proposal 1 specifies that RAN1 should discuss the capabilities of the UE, TRP and LMF for CPP. For example, UE capabilities for carrier phase positioning (CPP) specify if the UE can perform standalone CPP or joint legacy positioning with CPP. For example, UE capabilities for carrier phase measurement and reporting specify if the UE can perform a single frequency measurement or multiple frequency measurements within a PFL for CPP reporting. For example, PRU capability and configuration for double differential CPP specify if the UE can serve as a PRU for CPP based on the accuracy of its position and measurement capabilities.

A second proposal is for the UE's positioning processing capability. The duration of DL PRS symbols N in units of ms a UE can process every T ms assuming maximum DL PRS bandwidth in MHz, which is supported and reported by HE, should be updated especially in the case of joint traditional positioning with CPP due to the additional measurements needed.

The third proposal specifies that RAN1 should identify the information to be reported in feedback and the configuration for doing so, for the case of a single CP measurement within a PFL/carrier, and for the case of multiple CP measurements within a PFL/carrier.

A fourth proposal specifies that for UE-assisted NR carrier phase positioning, the carrier phase measured from the DL PRS signal(s) of a TRP should be reported as feedback to the LMF. Any differences with a reference TRP can be handled at the LMF.

A fifth proposal specifies that feedback from a UE/TRP to an LMF may include CP and legacy positioning feedback from the target UE and CP only from a PRU. DL NR carrier phase positioning can be UE-based or LMF-based. For UE based DL carrier phase positioning, the double differential measurements at the LME may need to be sent from the LMF to the UE estimating the position.

A sixth proposal specifies that the specification should support reporting the carrier phase of the first path only and the use of the use of LOS/NLOS indication for the carrier phase measurements.

### EXAMPLES

Example 1 includes a method comprising: receiving, at a network entity from a target user equipment (UE), first feedback data specifying a first position measurement including first carrier phase (CP) data; receiving, at the network entity from a position reference unit (PRU) UE, second feedback data specifying a second position measurement including second carrier phase data; and determining, at the network entity and based on the first feedback data and the second feedback data, a position estimate for the target UE.

Example 2 includes the method of example 1, further including sending, from the network entity to the target UE, first configuration data specifying a first timing for performing position measurements, the first configuration data based on capability data describing carrier phase measurement parameters for the target UE; sending, from the network entity to the PRU UE, second configuration data specifying a second timing for performing the position measurements, the second configuration data based on capability data of the PRU UE.

Example 3 includes the method of example 2, wherein the capability data specifies that the target UE is configured to support multi-frequency based CPP estimation.

Example 4 includes the method of example 3, wherein the multi-frequency based CPP estimation is based on a virtual frequency.

Example 5 includes the method of any of examples 2 to 4, wherein the capability data specifies that the target UE is configured to support a single frequency based CPP estimation.

Example 6 includes the method of any of examples 2 to 5, wherein the multi-frequency based CPP estimation is based on a multi-hypothesis integer ambiguity estimation.

Example 7 includes the method of any of examples 2 to 6, wherein the capability data specifies that the target UE is configured to support a combination of CPP measurement and at least one of downlink time of arrival (DL-TDOA) position measuring, uplink time difference of arrival (UL-TDOA) position measuring, and multi-round trip time (RTT) position measuring.

Example 8 includes the method of example 7, wherein the capability data specifies that the target UE is configured to support the combination for simultaneous processing of the CPP measurement at the at least one of the DL-TDOA position measuring, the UL-TDOA position measuring, and the multi-RTT position measuring.

Example 9 includes the method of any of examples 2 to 8, wherein the capability data specifies that the target UE is configured to support standalone CPP only.

Example 10 includes the method of any of examples 2 to 9, wherein the capability data specifies that the target UE is configured to support double differential CPP.

Example 11 includes the method of any of examples 2 to 10, wherein the capability data specifies that the target UE is configured to support a single CP measurement across multiple position frequency layers (PFLs) simultaneously.

Example 12 includes the method of any of examples 2 to 11, wherein the capability data specifies that the target UE is configured to support a single carrier phase measurement across multiple PFLs simultaneously with a time of arrival (TOA) estimation.

Example 13 includes the method of any of examples 2 to 12, wherein the capability data specifies that the target UE is configured to support a specified number of CP measurements across PFLs simultaneously.

Example 14 includes the method of any of examples 2 to 13, wherein the capability data specifies that the target UE is configured to support a specified number of CP measurements across PFLs sequentially.

Example 15 includes the method of any of examples 2 to 14, wherein the capability data specifies that the target UE is configured to support a specified number of position measurement occasions with a CPP measurement occasion in one or more report occasions.

Example 16 includes the method of any of examples 2 to 15, wherein the capability data specifies that the target UE is configured to associate a specified number of CPP measurement occasions with a position measurement occasion in one or more report occasions.

Example 17 includes the method of any of examples 2 to 16, wherein the capability data specifies that the target UE is configured to process a first number of DL PRS symbols in a period of time at a given periodicity for a given maximum bandwidth.

Example 18 includes the method of example 17, wherein the capability data specifies that the target UE is configured to process a CPP based on a first offset value for the first number of DL PRS symbols and based on a second offset value for the given periodicity.

Example 19 includes receiving, at a network entity from a position reference unit (PRU) user equipment UE, feedback data specifying a position measurement including carrier phase data; and sending, from the network entity to a target UE and based on the feedback data, assistance information specifying a range for calculation of an integer ambiguity value, wherein the target UE is configured to determine a position estimate based on the assistance information.

Example 20 includes the method of example 19, further comprising: receiving, at the network entity, capability data describing carrier phase (CP) measurement parameters for the target UE; receiving, at the network entity, PRU capability data; sending, to the PRU UE, first configuration data specifying a first timing for performing a first position measurement; sending, to a target UE, second configuration data specifying a second timing for performing a second position measurement, wherein the position estimate is based on the first position measurement and the second position measurement.

Example 21 includes the method of example 20, wherein the capability data specifies that the target UE is configured to support multi-frequency based CPP estimation.

Example 22 includes the method of any of examples 19 to 21, wherein the multi-frequency based CPP estimation is based on a virtual frequency.

Example 23 includes the method of any of examples 19 to 22, wherein the capability data specifies that the target UE is configured to support a single frequency based CPP estimation.

Example 24 includes the method of any of examples 19 to 23, wherein the multi-frequency based CPP estimation is based on a multi-hypothesis integer ambiguity estimation.

Example 25 includes the method of any of examples 20 to 24, wherein the capability data specifies that the target UE is configured to support a combination of CPP measurement and at least one of downlink time of arrival (DL-TDOA) position measuring, uplink time difference of arrival (UL-TDOA) position measuring, and multi-round trip time (RTT) position measuring.

Example 26 includes the method of example 25, wherein the capability data specifies that the target UE is configured to support the combination for simultaneous processing of the CPP measurement at the at least one of the DL-TDOA position measuring, the UL-TDOA position measuring, and the multi-RTT position measuring.

Example 27 includes the method of any of examples 20 to 26, wherein the capability data specifies that the target UE is configured to support standalone CPP only.

Example 28 includes the method of any of examples 20 to 27, wherein the capability data specifies that the target UE is configured to support double differential CPP.

Example 29 includes the method of any of examples 20 to 28, wherein the capability data specifies that the target UE is configured to support a single CP measurement across multiple position frequency layers (PFLs) simultaneously.

Example 30 includes the method of any of examples 20 to 29, wherein the capability data specifies that the target UE is configured to support a single carrier phase measurement across multiple PFLs simultaneously with a time of arrival (TOA) estimation.

Example 31 includes the method of any of examples 20 to 30, wherein the capability data specifies that the target UE is configured to support a specified number of CP measurements across PFLs simultaneously.

Example 32 includes the method of any of examples 20 to 31, wherein the capability data specifies that the target UE is configured to support a specified number of CP measurements across PFLs sequentially.

Example 33 includes the method of any of examples 20 to 32, wherein the capability data specifies that the target UE is configured to support a specified number of position measurement occasions with a CPP measurement occasion in one or more report occasions.

Example 34 includes the method of any of examples 20 to 33, wherein the capability data specifies that the target UE is configured to associate a specified number of CPP measurement occasions with a position measurement occasion in one or more report occasions.

Example 35 includes the method of any of examples 20 to 34, wherein the capability data specifies that the target UE is configured to process a first number of DL PRS symbols in a period of time at a given periodicity for a given maximum bandwidth.

Example 36 includes the method of example 35, wherein the capability data specifies that the target UE is configured to process a CPP based on a first offset value for the first number of DL PRS symbols and based on a second offset value for the given periodicity.

Example 37 includes a method comprising: receiving, at a network entity from a first transfer reference point (TRP), first feedback data specifying a first position measurement including first carrier phase data; receiving, at the network entity from a second TRP, second feedback data specifying a second position measurement including second carrier phase data; and determining, at the network entity and based on the first feedback data and the second feedback data, a position estimate for a target user equipment (UE).

Example 38 includes the method of example 37, further comprising: receiving, at the network entity, capability data describing carrier phase (CP) measurement parameters for the target UE; receiving, at the network entity, position reference unit (PRU) capability data; sending, to the target UE, the TRP, and the second TRP, first configuration data specifying a first timing for performing position measurements; sending, to a PRU UE, the first TRP, and the second TRP, second configuration data specifying a second timing for performing the position measurements.

Example 39 includes the method of any of examples 37 to 38, wherein the capability data specifies that the target UE is configured to support multi-frequency based CPP estimation.

Example 40 includes the method example 39, wherein the multi-frequency based CPP estimation is based on a virtual frequency.

Example 41 includes the method of any of examples 38 to 40, wherein the capability data specifies that the target UE is configured to support a single frequency based CPP estimation.

Example 42 includes the method of example 41, wherein the multi-frequency based CPP estimation is based on a multi-hypothesis integer ambiguity estimation.

Example 43 includes the method of any of examples 38 to 42, wherein the capability data specifies that the target UE is configured to support a combination of CPP measurement and at least one of downlink time of arrival (DL-TDOA) position measuring, uplink time difference of arrival (UL-TDOA) position measuring, and multi-round trip time (RTT) position measuring.

Example 44 includes the method of any of examples 38 to 43, wherein the capability data specifies that the target UE is configured to support the combination for simultaneous processing of the CPP measurement at the at least one of the DL-TDOA position measuring, the UL-TDOA position measuring, and the multi-RTT position measuring.

Example 45 includes the method of any of examples 38 to 44, wherein the capability data specifies that the target UE is configured to support standalone CPP only.

Example 46 includes the method of any of examples 38 to 45, wherein the capability data specifies that the target UE is configured to support double differential CPP.

Example 47 includes the method of any of examples 38 to 46, wherein the capability data specifies that the target UE is configured to support a single CP measurement across multiple position frequency layers (PFLs) simultaneously.

Example 48 includes the method of any of examples 38 to 47, wherein the capability data specifies that the target UE is configured to support a single carrier phase measurement across multiple PFLs simultaneously with a time of arrival (TOA) estimation.

Example 49 includes the method of any of examples 38 to 48, wherein the capability data specifies that the target UE is configured to support a specified number of CP measurements across PFLs simultaneously.

Example 50 includes the method of any of examples 38 to 49, wherein the capability data specifies that the target UE is configured to support a specified number of CP measurements across PFLs sequentially.

Example 51 includes the method of any of examples 38 to 50, wherein the capability data specifies that the target UE is configured to support a specified number of position measurement occasions with a CPP measurement occasion in one or more report occasions.

Example 52 includes the method of any of examples 38 to 51, wherein the capability data specifies that the target UE is configured to associate a specified number of CPP measurement occasions with a position measurement occasion in one or more report occasions.

Example 53 includes the method of any of examples 38 to 52, wherein the capability data specifies that the target UE is configured to process a first number of DL PRS symbols in a period of time at a given periodicity for a given maximum bandwidth.

Example 54 includes the method of example 53, wherein the capability data specifies that the target UE is configured to process a CPP based on a first offset value for the first number of DL PRS symbols and based on a second offset value for the given periodicity.

Example 55 may include an apparatus including logic, modules, and/or circuitry (e.g., processing circuitry) to perform one or more elements of a method described in or related to any of examples 1-54, or any other method or process described herein.

Example 56 may include a method, technique, or process as described in or related to any of examples 1-54, or portions or parts thereof.

Example 57 may include an apparatus including: one or more processors and one or more computer-readable media including instructions that, when executed by the one or more processors, cause the one or more processors to perform the method, techniques, or process as described in or related to any of examples 1-54, or portions thereof.

Example 58 may include a signal as described in or related to any of examples 1-54, or portions or parts thereof.

Example 59 may include a computer program including instructions, wherein execution of the program by a processing element is to cause the processing element to carry out the method, techniques, or process as described in or related to any of examples 1-45, or portions thereof. The operations or actions performed by the instructions executed by the processing element can include the methods of any one of examples 1-54.

Example 60 may include a method of communicating in a wireless network as shown and described herein.

Example 61 may include a system for providing wireless communication as shown and described herein. The operations or actions performed by the system can include the methods of any one of examples 1-54.

Example 62 may include a device for providing wireless communication as shown and described herein. The operations or actions performed by the device can include the methods of any one of examples 1-54.

The previously-described examples 1-54 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. One or more processors configured to perform operations comprising:
interfacing with a transceiver for receiving, at a network entity from a target user equipment (UE), first feedback data specifying a first position measurement including first carrier phase (CP) data;
interfacing with the transceiver for receiving, at the network entity from a position reference unit (PRU) UE, second feedback data specifying a second position measurement including second carrier phase data; and
determining, at the network entity and based on the first feedback data and the second feedback data, a position estimate for the target UE.

2. The one or more processors of claim 1, the operations further comprising:
interfacing with the transceiver for sending, from the network entity to the target UE, first configuration data specifying a first timing for performing position measurements, the first configuration data based on capability data describing carrier phase measurement parameters for the target UE;
interfacing with the transceiver for sending, from the network entity to the PRU UE, second configuration data specifying a second timing for performing the position measurements, the second configuration data based on capability data of the PRU UE.

3. The one or more processors of claim 2, wherein the capability data specifies that the target UE is configured to support multi-frequency based CPP estimation.

4. The one or more processors of claim 3, wherein the multi-frequency based CPP estimation is based on a virtual frequency.

5. The one or more processors of claim 2, wherein the capability data specifies that the target UE is configured to support a single frequency based CPP estimation.

6. The one or more processors of claim 3, wherein the multi-frequency based CPP estimation is based on a multi-hypothesis integer ambiguity estimation.

7. The one or more processors of claim 2, wherein the capability data specifies that the target UE is configured to support a combination of CPP measurement and at least one of downlink time of arrival (DL-TDOA) position measuring, uplink time difference of arrival (UL-TDOA) position measuring, and multi-round trip time (RTT) position measuring.

8. The one or more processors of claim 7, wherein the capability data specifies that the target UE is configured to support the combination for simultaneous processing of the CPP measurement at the at least one of the DL-TDOA position measuring, the UL-TDOA position measuring, and the multi-RTT position measuring.

9. The one or more processors of claim 2, wherein the capability data specifies that the target UE is configured to support standalone CPP only.

10. The one or more processors of claim 2, wherein the capability data specifies that the target UE is configured to support double differential CPP.

11. The one or more processors of claim 2, wherein the capability data specifies that the target UE is configured to support a single CP measurement across multiple position frequency layers (PFLs) simultaneously.

12. The one or more processors of claim 2, wherein the capability data specifies that the target UE is configured to support a single carrier phase measurement across multiple PFLs simultaneously with a time of arrival (TOA) estimation.

13. The one or more processors of claim 2, wherein the capability data specifies that the target UE is configured to support a specified number of CP measurements across PFLs simultaneously.

14. The one or more processors of claim 2, wherein the capability data specifies that the target UE is configured to support a specified number of CP measurements across PFLs sequentially.

15. The one or more processors of claim 2, wherein the capability data specifies that the target UE is configured to support a specified number of position measurement occasions with a CPP measurement occasion in one or more report occasions.

16. The one or more processors of claim 2, wherein the capability data specifies that the target UE is configured to associate a specified number of CPP measurement occasions with a position measurement occasion in one or more report occasions.

17. The one or more processors of claim 2, wherein the capability data specifies that the target UE is configured to process a first number of DL PRS symbols in a period of time at a given periodicity for a given maximum bandwidth.

18. The one or more processors of claim 17, wherein the capability data specifies that the target UE is configured to process a CPP based on a first offset value for the first number of DL PRS symbols and based on a second offset value for the given periodicity.

19. One or more processors configured to perform operations comprising:
interfacing with a transceiver for receiving, at a network entity from a position reference unit (PRU) user equipment UE, feedback data specifying a position measurement including carrier phase data; and
interfacing with the transceiver for sending, from the network entity to a target UE and based on the feedback data, assistance information specifying a range for calculation of an integer ambiguity value, wherein the target UE is configured to determine a position estimate based on the assistance information.

20. The one or more processors of claim 19, the operations further comprising:
interfacing with the transceiver for receiving, at the network entity, capability data describing carrier phase (CP) measurement parameters for the target UE;
interfacing with the transceiver for receiving, at the network entity, PRU capability data;
interfacing with the transceiver for sending, to the PRU UE, first configuration data specifying a first timing for performing a first position measurement;
interfacing with the transceiver for sending, to a target UE, second configuration data specifying a second timing for performing a second position measurement,
wherein the position estimate is based on the first position measurement and the second position measurement.

21. The one or more processors of claim 20, wherein the capability data specifies that the target UE is configured to support multi-frequency based CPP estimation.

22. The one or more processors of claim 21, wherein the multi-frequency based CPP estimation is based on a virtual frequency.

23. The one or more processors of claim 20, wherein the capability data specifies that the target UE is configured to support a single frequency based CPP estimation.

24. The one or more processors of claim 21, wherein the multi-frequency based CPP estimation is based on a multi-hypothesis integer ambiguity estimation.

25. The one or more processors of claim 20, wherein the capability data specifies that the target UE is configured to support a combination of CPP measurement and at least one of downlink time of arrival (DL-TDOA) position measuring, uplink time difference of arrival (UL-TDOA) position measuring, and multi-round trip time (RTT) position measuring.

26. The one or more processors of claim 25, wherein the capability data specifies that the target UE is configured to support the combination for simultaneous processing of the CPP measurement at the at least one of the DL-TDOA position measuring, the UL-TDOA position measuring, and the multi-RTT position measuring.

27. The one or more processors of claim 20, wherein the capability data specifies that the target UE is configured to support standalone CPP only.

28. The one or more processors of claim 20, wherein the capability data specifies that the target UE is configured to support double differential CPP.

29. The one or more processors of claim 20, wherein the capability data specifies that the target UE is configured to support a single CP measurement across multiple position frequency layers (PFLs) simultaneously.

30. The one or more processors of claim 20, wherein the capability data specifies that the target UE is configured to support a single carrier phase measurement across multiple PFLs simultaneously with a time of arrival (TOA) estimation.

31. The one or more processors of claim 20, wherein the capability data specifies that the target UE is configured to support a specified number of CP measurements across PFLs simultaneously.

32. The one or more processors of claim 20, wherein the capability data specifies that the target UE is configured to support a specified number of CP measurements across PFLs sequentially.

33. The one or more processors of claim 20, wherein the capability data specifies that the target UE is configured to support a specified number of position measurement occasions with a CPP measurement occasion in one or more report occasions.

34. The one or more processors of claim 20, wherein the capability data specifies that the target UE is configured to associate a specified number of CPP measurement occasions with a position measurement occasion in one or more report occasions.

35. The one or more processors of claim 20, wherein the capability data specifies that the target UE is configured to process a first number of DL PRS symbols in a period of time at a given periodicity for a given maximum bandwidth.

36. The one or more processors of claim 35, wherein the capability data specifies that the target UE is configured to process a CPP based on a first offset value for the first number of DL PRS symbols and based on a second offset value for the given periodicity.

37. One or more processors configured to perform operations comprising:
interfacing with a transceiver for receiving, at a network entity from a first transfer reference point (TRP), first feedback data specifying a first position measurement including first carrier phase data;
interfacing with the transceiver for receiving, at the network entity from a second TRP, second feedback data specifying a second position measurement including second carrier phase data; and
determining, at the network entity and based on the first feedback data and the second feedback data, a position estimate for a target user equipment (UE).

38. The one or more processors of claim 37, the operations further comprising:
interfacing with the transceiver for receiving, at the network entity, capability data describing carrier phase (CP) measurement parameters for the target UE;
interfacing with the transceiver for receiving, at the network entity, position reference unit (PRU) capability data;
interfacing with the transceiver for sending, to the target UE, the TRP, and the second TRP, first configuration data specifying a first timing for performing position measurements;
interfacing with the transceiver for sending, to a PRU UE, the first TRP, and the second TRP, second configuration data specifying a second timing for performing the position measurements.

39. The one or more processors of claim 38, wherein the capability data specifies that the target UE is configured to support multi-frequency based CPP estimation.

40. The one or more processors of claim 39, wherein the multi-frequency based CPP estimation is based on a virtual frequency.

41. The one or more processors of claim 38, wherein the capability data specifies that the target UE is configured to support a single frequency based CPP estimation.

42. The one or more processors of claim 39, wherein the multi-frequency based CPP estimation is based on a multi-hypothesis integer ambiguity estimation.

43. The one or more processors of claim 38, wherein the capability data specifies that the target UE is configured to support a combination of CPP measurement and at least one of downlink time of arrival (DL-TDOA) position measuring, uplink time difference of arrival (UL-TDOA) position measuring, and multi-round trip time (RTT) position measuring.

44. The one or more processors of claim 43, wherein the capability data specifies that the target UE is configured to support the combination for simultaneous processing of the CPP measurement at the at least one of the DL-TDOA position measuring, the UL-TDOA position measuring, and the multi-RTT position measuring.

45. The one or more processors of claim 38, wherein the capability data specifies that the target UE is configured to support standalone CPP only.

46. The one or more processors of claim 38, wherein the capability data specifies that the target UE is configured to support double differential CPP.

47. The one or more processors of claim 38, wherein the capability data specifies that the target UE is configured to support a single CP measurement across multiple position frequency layers (PFLs) simultaneously.

48. The one or more processors of claim 38, wherein the capability data specifies that the target UE is configured to support a single carrier phase measurement across multiple PFLs simultaneously with a time of arrival (TOA) estimation.

49. The one or more processors of claim 38, wherein the capability data specifies that the target UE is configured to support a specified number of CP measurements across PFLs simultaneously.

50. The one or more processors of claim 38, wherein the capability data specifies that the target UE is configured to support a specified number of CP measurements across PFLs sequentially.

51. The one or more processors of claim 38, wherein the capability data specifies that the target UE is configured to support a specified number of position measurement occasions with a CPP measurement occasion in one or more report occasions.

52. The one or more processors of claim 38, wherein the capability data specifies that the target UE is configured to associate a specified number of CPP measurement occasions with a position measurement occasion in one or more report occasions.

53. The one or more processors of claim 38, wherein the capability data specifies that the target UE is configured to process a first number of DL PRS symbols in a period of time at a given periodicity for a given maximum bandwidth.

54. The one or more processors of claim 53, wherein the capability data specifies that the target UE is configured to process a CPP based on a first offset value for the first number of DL PRS symbols and based on a second offset value for the given periodicity.

55. A non-transitory computer storage medium encoded with instructions that, when executed by one or more computers, cause the one or more computers to perform the operations of any preceding claim.

56. A system comprising one or more processors and one or more storage devices on which are stored instructions that are operable, when executed by the one or more processors, to cause the one or more processors to perform the operations of any of claims 1 to 54.

57. A method of performing the operations of any of claims 1 to 54.
